(19) United States
(12) Patent Application Publication
(10) Pub. No.: US 2016/0260064 A1
(43) Pub. Date: Sep. 8, 2016

(54) SYSTEMS AND METHODS FOR A CAREER AND COURSES PORTAL

(71) Applicant: Gradberry Inc., San Jose, CA (US)

(72) Inventors: Syed A. Ahmed, Santa Clara, CA (US); Iba Masood, Santa Clara, CA (US)

(21) Appl. No.: 15/059,703

(22) Filed: Mar. 3, 2016

Related U.S. Application Data
(60) Provisional application No. 62/127,578, filed on Mar. 3, 2015.

(51) Int. Cl. G06Q 10/10; H04L 29/08; G06F 17/30

(52) U.S. Cl. CPC G06Q 10/1053; G06F 17/3056; H04L 67/306

(57) ABSTRACT

The present application is directed to systems and methods for a career and courses portal. Users of the portal may be students or recent graduates, or employers. The portal may utilize gamification, or providing game-like achievement features such as awards or badges, to encourage users to enroll in and take courses, take assessment tests, edit their profiles, look for career opportunities, etc. Employers may place job openings on the portal and associate skill requirements with the job openings. Users who possess the skill requirements may qualify for these job openings. The portal may operate under a freemium model, where some services are available to users without charge and other services are behind a paywall. The portal may also charge employers for some services. The portal may utilize an algorithm that matches jobs and courses for each user. The portal may include a leaderboard system. The portal may determine one or more trending jobs.

### RELATED APPLICATIONS

This application claims priority to and the benefit of U.S. Provisional Application No. 62/127,578, entitled “Systems and Methods for a Career and Courses Portal,” filed Mar. 3, 2015, the entirety of which is hereby incorporated by reference.

### FIELD OF THE DISCLOSURE

The present disclosure generally relates to systems and methods for a career and courses portal, platform, and website.

### BACKGROUND

Many who are unemployed and underemployed are recent graduates from institutions of higher education. At the same time, many employers have unfilled positions due to the fact that institutions of higher education often do not adequately train their students with skills they need for these positions.

### SUMMARY

The present application is directed to systems and methods for a career and courses portal. Users of the portal may be students or recent graduates, or employers. The portal may utilize gamification, or providing game-like achievement features such as awards or badges, to encourage users to enroll in and take courses, take assessment tests, edit their profiles, look for career opportunities, etc. Employers may place job openings on the portal and associate skill requirements with the job openings. Users who possess the skill requirements may qualify for these job openings. The portal may operate under a freemium model, where some services are available to users without charge and other services are behind a paywall. The portal may also charge employers for some services. The portal may utilize an algorithm that matches jobs and courses for each user. The portal may include a leaderboard system. The portal may determine one or more trending jobs.

### BRIEF DESCRIPTION OF THE FIGURES

The foregoing and other objects, aspects, features, and advantages of this disclosure will become more apparent and better understood by referring to the following description taken in conjunction with the accompanying drawings, in which:

FIG. 1A is a flowchart of an implementation of a method of matching jobs and courses to a user;

FIG. 1B is a flowchart of an implementation of a method of ranking possible jobs for a user based on a preferred skills score;

FIG. 1C is a flowchart of an implementation of a method of selecting a career path for a user;

FIG. 2 is a flowchart of an implementation of a method of determining a leaderboard;

FIG. 3A is a flowchart of an implementation of a method of determining trending skills;

FIG. 3B depicts an implementation of a system for generating a course selection list;

FIG. 4 depicts an embodiment of an interface provided on a computing device for trending skills;

FIG. 5 depicts an embodiment of an interface provided on a computing device for a course;

FIG. 6 depicts an embodiment of an interface provided on a computing device for employers to view applicants to job openings;

FIG. 7 depicts an embodiment of an interface provided on a computing device of a user profile;

FIG. 8 depicts an embodiment of an interface provided on a computing device for viewing courses;

FIG. 9 depicts an embodiment of an interface provided on a computing device for viewing job openings;

FIG. 10 depicts an embodiment of an interface provided on a computing device for a news feed, job applications, and achievements;

FIG. 11A is a block diagram depicting an embodiment of a network environment comprising local devices in communication with remote devices; and

FIGS. 11B-11D are block diagrams depicting embodiments of computers useful in connection with the methods and systems described herein.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In many markets, there exists a high unemployment rate along with a high rate of unfilled employment positions. This mismatch may be due to a lack of adequately skilled potential employees, and may reflect a failure of higher education to fulfill the needs of the labor market. Accordingly, the systems and methods described herein provide a career and courses portal to identify skills required by employers, and provide students or recent graduates identification of continued educational opportunities or courses to provide said skills. To encourage participation, the portal may utilize gamification features such as awards or badges for enrolling in and taking courses, taking assessment tests, updating profiles or resumes, looking for career opportunities, etc.

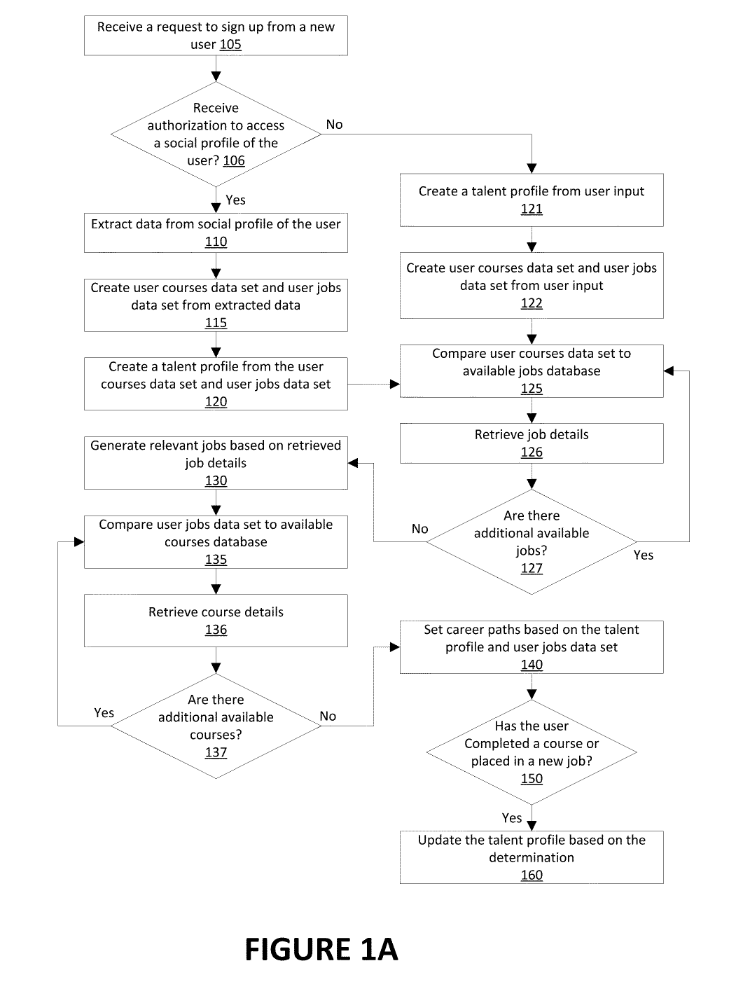

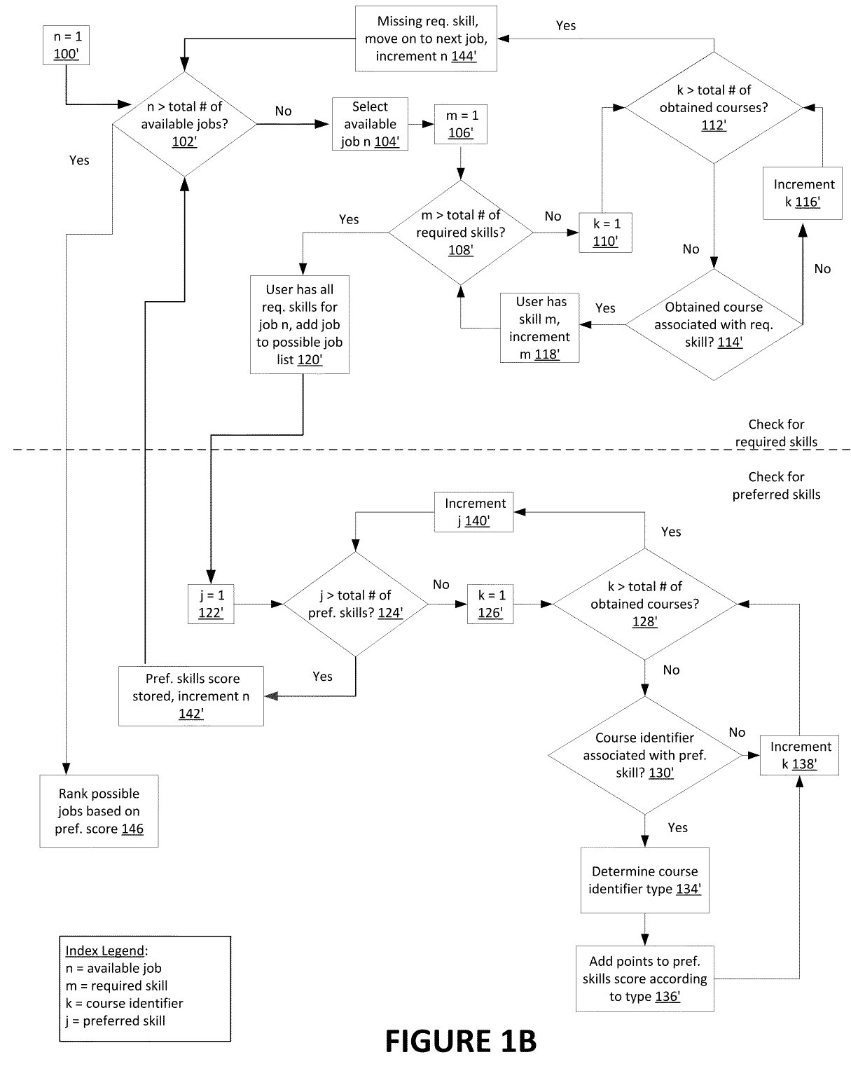

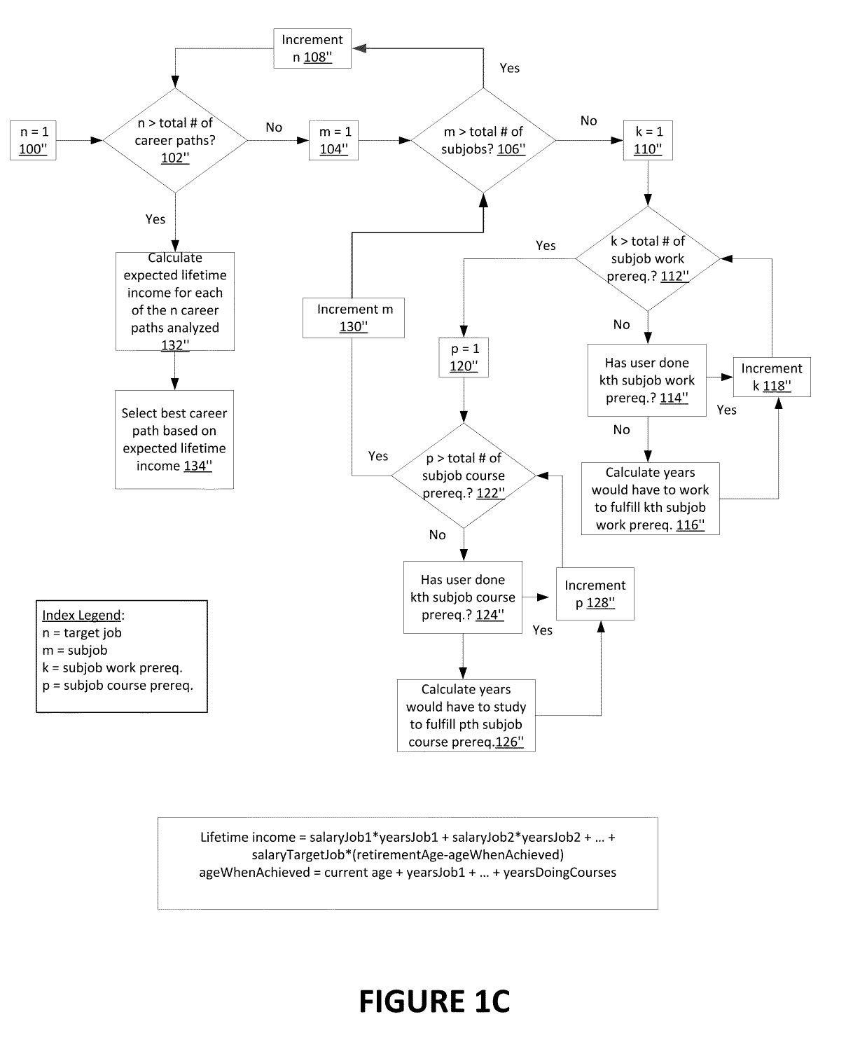

FIG. 1A is a flowchart of an implementation of a method of matching jobs and courses to a user. In brief overview, at step 105, a server may receive a request to sign up from a new user. At step 106, the server may receive authorization to access a social profile of the user. At step 110, if the server had received the authorization at step 106, the server may extract data from the social profile of the user. At step 115, the server may create user courses data set and user jobs data set from the extracted data. At step 120, the server may create a talent profile from the user courses data set and user jobs data set. At step 121, if the server had not received the authorization at step 106, the server may create a talent profile from user input. At step 122, the server may create user courses data set and user jobs data set from user input. At step 125, the server may compare user courses data set to available jobs database. At step 126, the server may retrieve job details. At step 127, the server may determine whether there are additional available jobs. If there are additional available jobs, the server may repeat step 125. If there are no additional available jobs, at step 130, the server may generate relevant jobs based on retrieve job details. At step 135, the server may compare user jobs data set to available courses database. At step 136, the server may retrieve course details. At step 137, the server may determine whether there are additional available courses. If there are additional available courses, the server may repeat step 135. If there are no additional available courses, at step 140, the server may set career paths based on the talent profiles and user jobs data set. At step 150, the server may determine whether the user completed a new course or has been placed in a new job. If so, at step 160, the server may update the talent profile based on the determination.

Still referring to FIG. 1A, and in more detail, at step 105, a server may receive a request to sign up from a new user. The server may be a physical computing device, a virtual computing device executed by a processor of a physical computing device, a cloud or farm of servers or computing devices, or any other type and form of server. The server may receive the request via a network, such as a wide area network or local area network, the request transmitted by a second computing device operating on behalf of the new user, such as a laptop, desktop, or portable computer, smartphone, tablet computer, or other computing device. The server may be part of a group of servers that provide a platform that allows user to sign up and matches the user to jobs and courses. The platform may be an exclusive, members-only platform that requires users to sign up. In some implementations, the method may be performed by one or more virtual machines. In some implementations, the method may be performed via an application programmable interface (API). The server may provide an API that may be used to perform the method.

At step 106, the server may receive authorization to access a social profile of the user. The social profile may be associated with the user. The social profile may be part of, or stored under, a social networking site such as FACEBOOK or LINKEDIN. The social networking site may require an authorization from a user for the server to access to social profile (such as a social account) of the user. In some implementations, the server may send a request to the user to provide authorization. The authorization or the request for authorization may use an API provided by the social networking site. In some implementations, the server may receive authorization to access a plurality of social profiles of the user from a plurality of social networking sites. In some implementations, users are given a choice on signing up with one of a plurality of social networking sites (e.g. either LINKEDIN or FACEBOOK) or with both social networking sites. The social profile may comprise one or more fields such as job history, certifications, internships, educational history, field of study, degrees, skills, interests, extracurricular, geographic location, etc. In some implementations, a server may be a collecting front end. The collecting front end may login via FACEBOOK or LINKEDIN or other logins.

At step 110, if the server had received the authorization at step 106, the server may extract data from the social profile of the user. The server may use the authorized access to the user's social profile to extract and save all the social profile information (which is received in plain text) on to a memory, database, storage, and/or cloud servers. The server may extract one or more fields from the social profile. The server may extract one or more fields from the social profile. The collecting front-end may extract profiles to a raw text profile by taking the right keywords from unstructured data. The raw text profile and/or the unstructured text may be converted to a structured profile for the platform including a skills listing for the user.

At step 115, the server may create a user courses data set and a user jobs data set from the extracted data. The server may run operations on the extracted data to make two data sets out of the fields extracted, e.g., one for jobs and one for courses. The user courses data set may include fields such as educational history, certifications, extracurricular and interest. The user jobs data set may include fields such as previous work experience, internships, and field of study. The data sets may be stored together in a single database (e.g. as a record in a database), may be stored separately and associated within a single database (e.g. as separate records linked in a relational database), or may be stored separately and otherwise associated.

At step 120, the server may create a talent profile from the user courses data set and user jobs data set. The server may combine the jobs data set and the courses data set to create the user's talent profile on the platform automatically. Creating the talent profile from the user courses data set and the user jobs data set decreases the time needed to create the talent profile as compared to the user creating the talent profile from scratch. The employers can see the talent profile (also referred to as an online profile) such that employers can immediately find a user when the user signs up and the talent profile is automatically created. In some implementations, the server may be unable to fill in one or more fields due to the social profile lacking the fields, or due to a lack of access privileges to the social profile. In some implementations, the server may notify the user of one or more fields that are not filled in the talent profile and suggest that the user fill in those fields. The user may manually fill in any fields that have not been extracted from the social profile via the user courses data set and the user jobs data set.

At step 121, if the server had not received the authorization at step 106, the server may create a talent profile from user input. In some implementations, the server may not have received authorization because a social profile of the user does not exist. In other implementations, the user or social networking system may have denied access to a social profile. The server may receive from the user one or more fields for the talent profile. For instance, the server may receive the user's job experience, educational background, certifications, etc.

At step 122, the server may create the user courses data set and the user jobs data set from user input, such as responses to a questionnaire. The server may run operations on the user input to make two data sets, one for jobs and one for courses. The user courses data set may include fields such as educational history, certifications, extracurricular and interest. The user jobs data set may include fields such as previous work experience, internships, and field of study.

At step 125, the server may compare user courses data set to available jobs database. The server may compare or match one or more fields from the user courses data set with available jobs database. A job and course data set may be matched based on one or more traits. For example, in one implementation, the server may determine that an available job matches the user's courses data set based on the job including or identifying a skill and the courses data set including or identifying the skill. In another implementation, a plurality of items in a job and data set may be matched for the server to identify the job as a potential match for the user. For example, the available jobs database may store a plurality of jobs, and each job may be associated with an educational requirement, certification requirement, skills requirement, and/or other requirements. The server may match educational requirements of jobs with educational history in the user courses data set. The server may match certifications requirements of jobs with certification in the user courses data set. The server may match skills requirements of jobs with skills in the user courses data set. In some implementations, a plurality of said requirements, certifications, and/or skills in the job and data set may match for the server to consider the job to be a match for the user. The available jobs database may include a plurality of jobs that are posted on the platform. The plurality of jobs may have been posted by a plurality of employers. Although described in terms of matching, in many implementations, job requirements may include ranges (e.g. 3-5 years of experience), and a user may be considered to “match” if the user has a corresponding skill or resume feature that falls within the required range.

At step 126, the server may retrieve job details based on the comparison. For instance, a job from the available jobs database may have matched when compared to the user courses data set. The details on the job that has matched may be retrieved.

At step 127, the server may determine whether there are additional available jobs. The server may determine, for instance, whether there are additional jobs in the available jobs database that has not yet been compared to the user courses data set. If there are additional jobs in the available jobs database that have not been compared to the user courses data set, the server may further compare user courses data set to available jobs database at step 125. Otherwise, the server may continue to step 130. In some implementations, all jobs in the database may be compared to give a comprehensive list of potential jobs to the user; in other implementations, a subset of jobs may be compared. For example, in one implementation, the user may be presented with the first n matching jobs reviewed by the system in order from the oldest posted job to newest posted job. This may help weight the matching system to fill positions that have been open the longest.

At step 130, the server may generate relevant jobs based on the retrieved job details. In some implementations, a plurality of job details may have been retrieved. In some implementations, the server may generate relevant jobs based on user courses data set. The server may utilize an algorithm that selects the most relevant job or jobs. In some implementations, the most relevant job may be based on the comparison or the match of user courses data set and the plurality of jobs in the available jobs database. In some implementations, the server or the algorithm may select a set of relevant information from the user courses data set. For instance, the server may select a most recent degree that the user has earned, and select as most relevant one or more jobs that requires such degree. In some implementations, the server or the algorithm may compute or calculate a score (such as a weight sum) for each job in the plurality of jobs, and select one or more jobs of the plurality of jobs with the highest scores as most relevant jobs. The server may then display the most relevant jobs, which may be associated with the user's educational background. In some implementations, users coming on board may be assumed to have little or no experience (for instance, students or recent graduates) so the server may use the user's educational history for the first time to generate relevant jobs. The relevant jobs, also referred to as recommended jobs, may be displayed to the user. The relevant jobs may be part of a user feed suggestion or a news feed.

At step 135, the server may compare or match the user jobs data set to an available courses database. The fields from the user jobs data set are matched with the available courses database, which comprises a plurality of courses, and each course may be associated with one or more jobs, skills, certifications, and other fields that may be found in the user jobs data set. For instance, a field in the user jobs data set may be previous work experience. The server may compare or match the previous work experience with one or more jobs associated with each plurality of courses in the available courses database, thus identifying a subset of courses from the plurality of courses. Each course in the subset of courses may be associated with one or more jobs that matches the previous work experience of the user jobs data set. In some implementations, the server may match one or more skills associated with jobs in user job data set and/or talent profile with skill upgrades (such as courses) available on the platform. The skill upgrades and courses may be part of a user feed suggestion.

At step 136, the server may retrieve course details. The server may retrieve course details based on the comparison of user jobs data set to available courses database. The retrieved course details may be retrieved from the available courses database. The identification or metadata of the retrieved course details may have matched when compared to the user jobs data set.

At step 137, the server may determine whether there are additional available courses. If there are, the server may repeat step 135. The server may determine, for instance, whether there are additional courses in the available courses database that has not yet been compared to the user jobs data set. If there are additional courses in the available courses database that have not been compared to the user jobs data set, the server may further compare user courses data set to available courses database at step 135. Otherwise, the server may continue to step 140. In other implementations, the server may review a subset of courses, such as a number of courses with open enrollment, courses geographically proximate to the user, etc.

At step 140, the server may set career paths based on the talent profiles and user jobs data set. The server may user an algorithm to identify one or more career paths. The server or the algorithm may identify one or more career paths from a database of career paths. Each career path may comprise one or more jobs, and the one or more jobs may be connected to indicate progression from one job to another. The algorithm may identify one or more career paths based on the user jobs data set, the talent profile and/or the subset of courses. For instance, the talent profile and/or the user jobs data set may include two jobs in which the user was previously employed, and the algorithm may select a career path that includes both jobs. In another instance, a set of jobs may be identified from the subset of courses, and the set of jobs may be used to identify the one or more career paths. In some implementations, the server may identify a predefined number of career paths from the database of career paths. In some implementations, the server may identify the predefined number of career paths that matches best with the user jobs data set, the talent profile and/or the talent profile. For instance, the server may identify the top two or three career paths. The career paths may be part of a user feed suggestion.

At step 150, the server may determine whether the user completed a course or placed in a new job. In some implementations, the server may also determine whether the user enrolled in a course. The server may receive an indication that the user has completed the course. For instance, the user may take an assessment test associated with a course, and upon successful completion of the assessment test, the server may receive the indication that the user has completed the course. In some implementations, the server may receive an update from the user indicating that the user placed in a new job. For instance, the user may send an update to the platform. In another instance, an employer may indicate that the user has been placed in the new job provided by the employer. In some implementations, the server may periodically re-extract data from the one or more social profiles to determine that the user has completed a course, or placed in a new job. The periodicity of when the server re-extracts data may be set to between a day to a year. In some implementations, a course may be completed on the platform and upon completion of the course, the server will automatically detect that the course was completed and proceed to step 160. In some implementations, the server may automatically detect that the job was secured through the platform and proceed to step 160.

At step 160, if the user has completed a course or placed in a new job, the server may update the talent profile based on the determination. In some implementations, the server may add the completed course to the talent profile. In some implementations, the server may add the new job to the talent profile. The server may use a self-learning algorithm to monitor changes on the talent profile. The server and/or the self-learning algorithm may update a user feed suggestions based on updates to the talent profile. The user feed suggestions may include, for instance, a set of skills and jobs. The skills and jobs may change as the talent profile is updated and as the user progresses and learns more skills and is placed in new jobs.

Referring to FIG. 1B in a general overview, FIG. 1B is a flowchart of an implementation of a method of ranking potential jobs based on a user's previous course history. The ranking may be used to generate a list of relevant jobs for a user. The method involves searching for skills required by each available job by searching each of a user's previously obtained courses to determine if the course is associated with the required skill. If a course is found that is associated with the required skill, proceed to searching each course to determine if the course is associated with any preferred skill. The method proceeds to add a weighted score for each course associated with a preferred skill to calculating a preferred skills score, which can be used to rank jobs by their suitability for the user based on the user's skills.

Still referring to FIG. 1B, and in more detail, in an implementation, at step 100′ a career server may set an index n to 1. The index may index available jobs retrieved by a server from an available jobs database on a storage device. The available jobs database may be managed by a same party who manages the server, or may managed by a third party.

In an implementation, at step 102′ a career server or a skill matcher may compare the index value n to the total number of available jobs being analyzed. Comparing the index value to the total number of the available jobs being analyzed may comprise a bitwise comparison of data strings (e.g. an XOR with a result of 0 indicating the index is equal to the threshold); calculating a difference between the total number of available jobs being analyzed and the index and determining if the result is negative, positive, or zero; or any other such method. This may help determine whether all of the available jobs have been analyzed. If the index value n is greater than the of available jobs being analyzed, the server may proceed to step 120′ to begin analysis of preferred skills. If not, the server may proceed to step 104′.

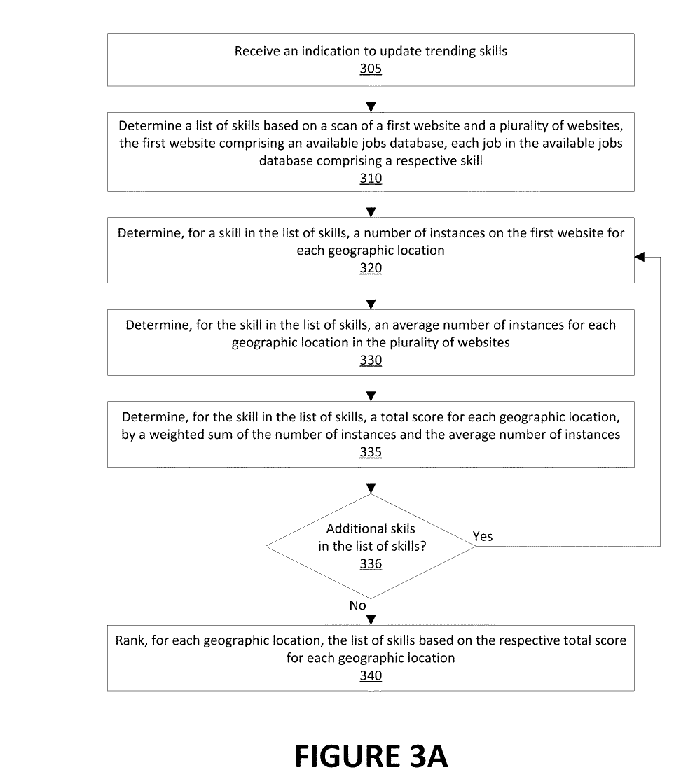

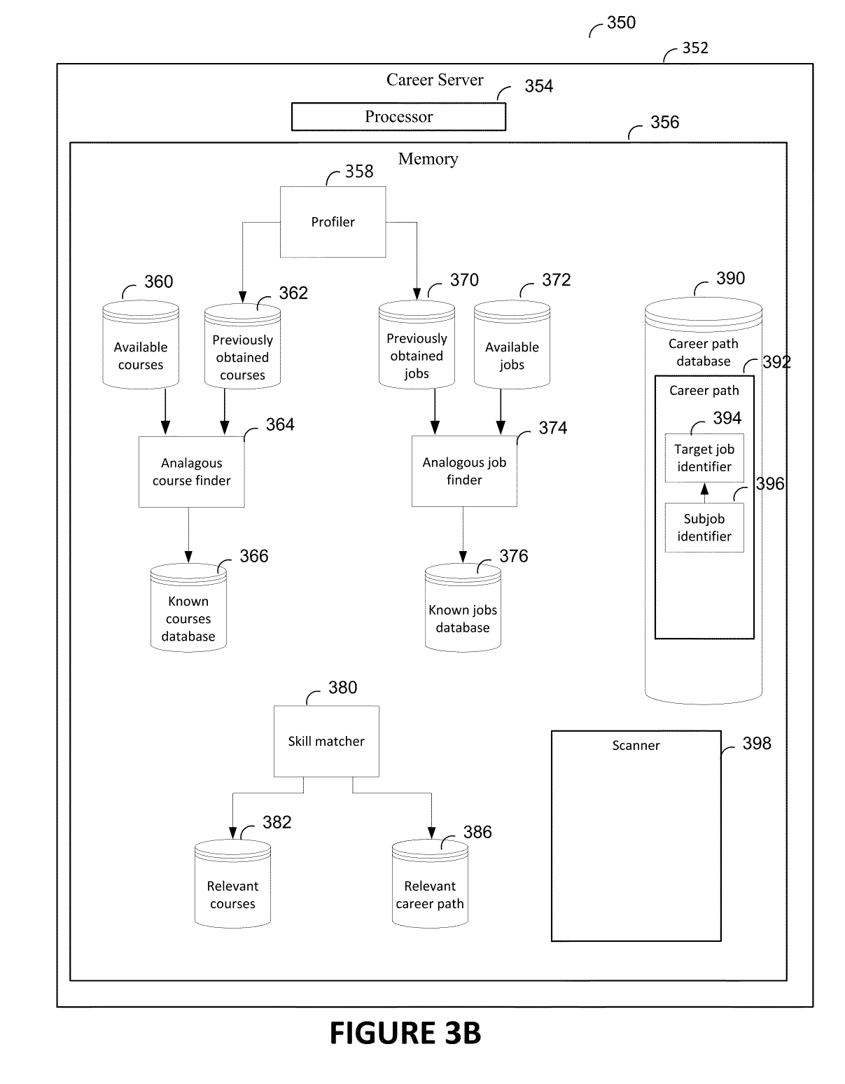

In an implementation, at step 104′, a career server may select available job n. Available job n may be associated with required skills and preferred skills. For example, an analogous job finder executed by a server and discussed in more detail below in connection with FIG. 3B may identify skills as associated with a known predetermined job, and may identify the available job as corresponding to the predetermined job. For example, jobs may be listed differently on different third party sites, job listings, or servers, but may be related (e.g. “accountant”, “accountant I”, “junior accountant”, “associate accountant”, “CPA”, etc.). The analogous job finder may maintain a database of predetermined job classifications or identifiers, and may determine that a job listing corresponds to a predetermined classification (e.g. “accountant”). The determination may be done via keyword analysis, title and wildcard analysis, or may involve more complex systems, such as a Bayesian algorithm to compare a plurality of job characteristics to the predetermined job. Such characteristics may include titles, description keywords or text, hours per week, salary ranges, location, required educational titles, years of experience, skills, company names, or any other such information. Accordingly, rather than merely comparing titles, the analogous job finder may generate a string or vector of correlations or comparisons between corresponding characteristics of each job listing and the predetermined classifications to identify a most likely corresponding classification.

In an implementation, at step 106′ a career server may set m to 1, m being the index for required skills. The index m runs from 1 through the total number of required skills associated with job n, as determined by e.g. an analogous job finder.

In an implementation, at step 108′ a career server may compare the index value m to the total number of required skills. Comparing the index value to the total number of required skills may comprise a bitwise comparison of data strings (e.g. an XOR with a result of 0 indicating the index is equal to the threshold); calculating a difference between the total number of required skills and the index and determining if the result is negative, positive, or zero; or any other such method. This may help determine whether all required skills have been analyzed. If the index value m is greater than the total number of required skills, proceed to step 120′ to begin analysis of preferred skills. If not, proceed to step 110′.

In an implementation, at step 110′ a career server may set k to 1, k being the index of obtained courses. The index k runs from 1 through the total number of obtained courses.

In an implementation, at step 112′ a career server may compare the index value k to the total number of obtained courses associated with a user. Comparing the index value to the total number of obtained courses associated with a user may comprise a bitwise comparison of data strings (e.g. an XOR with a result of 0 indicating the index is equal to the threshold); calculating a difference between the total number of obtained courses associated with a user and the index and determining if the result is negative, positive, or zero; or any other such method. This may help determine whether all of the obtained courses associated with a user have been analyzed. If the index value k is greater than the total number of obtained courses associated with a user, a required skill is missing and the available job being analyzed should not be recommended to the user. The server may proceed to step 144′ to move on to the next available job. If the index value k is greater than the total number of obtained courses associated with a user, the server may proceed to step 114′.

In an implementation, at step 114′ an analogous course finder, discussed below in more detail in connection with FIG. 3B, may determine whether the k^{th} course identifier is associated with a required skill. For example, an analogous course finder may identify skills as associated with a known predetermined course, and may identify the available job as corresponding to the predetermined course. Similar to the analogous job finder discussed above, the analogous course finder may perform one or more comparisons of courses listed by third parties (e.g. universities, technical schools, etc.) to a predetermined set of courses or classifications to normalize different descriptions by the schools. The comparisons may be based on titles, descriptions, prerequisites, listed reading materials, credits, course fees, required hours of lab work, or any other such information. As discussed above, in some implementations, the comparisons may be a multivariate Bayesian comparison of characteristics to determine a most likely corresponding course in the predetermined set. If the course identifier is associated with a required skill, proceed to step 118′. If not, the server may proceed to step 116′ where k is incremented, and from there to step 112′ to analyze the next obtained course.

In an implementation, at step 118′, index m is incremented to begin analysis of the next required skill.

In an implementation, at step 120′, every required skill associated with available job n may have been found to be associated with the user. The server may add the job n to a list of possible jobs. This list may, for example, later be used to generate a list of relevant jobs, e.g. once preferred skills for the possible jobs are taken in to account.

In an implementation, at step 122′ a career server may set the index j to 1, j being the index of preferred skills. The index j runs from 1 through the total number of obtained preferred skills associated with available job n, as determined, e.g., an analogous job finder. For example, an analogous job finder may identify preferred skills as associated with a known predetermined job, and may identify the available job as corresponding to the predetermined job.

In an implementation, at step 124′ a career server may compare the index value j to the total number of preferred skills associated with the available job. Comparing the index value to the total number of preferred skills associated with the available job may comprise a bitwise comparison of data strings (e.g. an XOR with a result of 0 indicating the index is equal to the threshold); calculating a difference between the total number of preferred skills associated with the available job and the index and determining if the result is negative, positive, or zero; or any other such method. This may help determine whether all of the preferred skills associated with the available job have been analyzed. If the index value j is greater than the total number of preferred skills associated with the available job, proceed to step 142′ to tally the preferred skills score. Otherwise, proceed to step 126′.

In an implementation, at step 126′ a career server may set k to 1, k being the index of obtained courses. The index k runs from 1 through the total number of obtained courses.

In an implementation, at step 128′ a career server or a skill matcher may compare the index value k to the total number of total number of obtained courses. Comparing the index value to the total number of total number of obtained courses may comprise a bitwise comparison of data strings (e.g. an XOR with a result of 0 indicating the index is equal to the threshold); calculating a difference between the total number total number of obtained courses and the index and determining if the result is negative, positive, or zero; or any other such method. This may help determine whether all of the total number of obtained courses have been analyzed. If the index value k is greater than the total number total number of obtained courses, the server may proceed to step 140′ increment j. Otherwise, the server may proceed to step 130′.

In an implementation, at step 130′ an analogous course finder may verify whether the k^{th} obtained course is associated with preferred skill j. For example, an analogous course finder may identify preferred skills as associated with a known predetermined course, and may identify the available course as corresponding to the predetermined course. If the kth obtained course is associated with preferred skill j, the server may proceed to step 134′. If it is not, the server may proceed to step 138′, where k is incremented.

In an implementation, at step 134′ a career server or analogous course finder may determine a course type for the k^{th} obtained course. This may be used to factor in the strength of the obtained course's association with the preferred skill at 136′ when calculating a preferred skills score. For example, the course type may be for an introductory level course, or for a higher level course, or for any appropriate course type, and weights for preferred skills points may vary among those types.

In an implementation, at step 136′ a career server may add points to a preferred skills score for job n according to the type determined at step 134′. For example, 1 point may be added for an introductory level course, while 2 points may be added for a higher level course. Other numbers of points may be added as well, e.g. 0 points for a course type deemed to be simple. This may help to more heavily weigh a higher level course in terms of preferred skills points, which may reflect a higher percent chance of having acquired the preferred skill from a higher level course than from a lower level course.

In an implementation, at step 138′ a career server may increment k, and the next course identifier may be analyzed.

In an implementation, at step 140′ a career server may increment j, and a next preferred skill may be analyzed.

In an implementation, at step 142′ a career server may store the preferred skills score in a database of preferred skills scores for the user. Index n may be incremented to being analysis of the next available job.

In an implementation, at step 144′, a career server may determine that a required skill is missing. The index n is incremented, and analysis may begin for the next job in the list. By completing the determination of whether a required skill is missing before beginning a preferred skills analysis, the method saves time and computing power in the event that a required skill is missed and the job is not suitable for the user.

In an implementation, at step 146′ a career server may rank available jobs based on the recorded preferred skills score. A plurality of the highest ranking jobs may serve as a recommended or relevant jobs list.

Referring to FIG. 1C in an overview, FIG. 1C depicts an implementation of a method of determining a best career path based on expected lifetime income.

Still referring to FIG. 1C, and in more detail, in an implementation, at step 100″ a career server may set n to 1, n being an index of career paths. As described below in reference to FIG. 3C, a career path may be a set of jobs including a target job and at least one subjob. The target job and the subjobs may be related in that the subjobs may lead to the target job. For example, the subjob may be associated with prerequisites of the target jobs. The subjobs may be prerequisite work experiences required before a target job can be obtained. The subjobs may also be learning experiences that teach skill prerequisites of the target job. The subjobs may also lead to the target jobs in other ways, for example, people with the subjobs may be commonly promoted to the target job, e.g. an associate position may be a subjob for a partner position target job, or an “accountant I” may be a subjob of an “accountant II” position, which may itself be a subjob of an “accountant III” position. Accordingly, subjobs may be referred to variously as starting or intermediate positions, jobs along a career path, precursor jobs, prerequisite jobs, or by other such terms.

In an implementation, at step 102″ a career server or a skill matcher may compare the index value n to the total number of career paths to be analyzed. Comparing the index value to the total number of career paths to be analyzed may comprise a bitwise comparison of data strings (e.g. an XOR with a result of 0 indicating the index is equal to the threshold); calculating a difference between the total number of career paths to be analyzed and the index and determining if the result is negative, positive, or zero; or any other such method. This may help determine whether all of the career paths have been analyzed. If the index value n is greater than the total number of career paths to be analyzed, the server may proceed to step 132″ to calculate the expected lifetime income for each career path. Otherwise, the server may proceed to step 104″.

In an implementation, at step 104″ a career server may set m to 1, m being an index of subjobs. The index k runs from 1 through the total number of subjobs for the particular career path.

In an implementation, at step 106″ a career server may compare the index value m to the total number of subjobs associated with the career path. Comparing the index value to the total number of subjobs associated with a career path may comprise a bitwise comparison of data strings (e.g. an XOR with a result of 0 indicating the index is equal to the threshold); calculating a difference between the total number of subjobs associated with the career path and the index and determining if the result is negative, positive, or zero; or any other such method. This may help determine whether all of the subjobs associated with the career path have been analyzed. If the index value m is greater than the total number of subjobs associated with the career path, proceed to step 108″, increment n, and move on to analysis of the next career path. Otherwise, proceed to step 106″.

In an implementation, at step 110″ a career server may set k to 1, k being an index of subjob work prerequisites. A work prerequisite may be e.g. a required previous work experience. The work prerequisites may be any type of job, including subjobs, obtained jobs, etc. The work prerequisite may be determined by e.g. the server accessing a lookup table of a career path database to determine an associated work prerequisite for the subjob under analysis, or may be determined in any other appropriate manner.

In an implementation, at step 112″ a career server may compare the index value k to the total number of subjob work prerequisites. Comparing the index value to the total number of subjob work prerequisites may comprise a bitwise comparison of data strings (e.g. an XOR with a result of 0 indicating the index is equal to the threshold); calculating a difference between the total number of subjob work prerequisites and the index and determining if the result is negative, positive, or zero; or any other such method. This may help determine whether all of the subjob work prerequisites have been analyzed. If the index value k is greater than the total number of subjob work prerequisites, the server may proceed to step 120″, increment p, and move on to analysis of subjob course prerequisites. Otherwise, the server may proceed to step 114″.

In an implementation, at step 114″ an analogous job finder may determine whether user has completed the subjob work prerequisite. This may be performed by the analogous job finder determining whether the subjob work prerequisite is corresponds to a job in the previously obtained jobs database. If the user has completed the subjob work prerequisite, proceed to step 118″. If not, proceed to step 116″.

In an implementation, at step 116″ a career server may calculate the years that would have to be worked to fulfill the subjob work prerequisite. This may be determined by the server referring to e.g. a lookup table in the career path database, or by the server referring to metadata associated with the subjob work prerequisite, or by any other appropriate manner. The calculation may involve subtracting any years previously worked by the user at the subjob work prerequisite that was not completed, as determined by e.g. user information provided to the server as part of a request to determine a career path.

In an implementation, at step 118″ a career server may increment k, so that the next subjob work prerequisite may be analyzed.

In an implementation, at step 120″ a career server may set p to 1, p being an index of subjob course prerequisites. Subjob course prerequisites may be any required previous course completions. The course prerequisites may be any time of course, including high school courses, college courses, trade school courses, online courses, or any other courses. The course prerequisites may be determined by, for example, the server accessing a lookup table of a career path database to determine an associated course prerequisite for the subjob under analysis, or may be determined in any other appropriate manner.

In an implementation, at step 122″ a career server may compare the index value p to the total number of subjob course prerequisites. Comparing the index value to the total number of subjob course prerequisites may comprise a bitwise comparison of data strings (e.g. an XOR with a result of 0 indicating the index is equal to the threshold); calculating a difference between the total number of subjob course prerequisites and the index and determining if the result is negative, positive, or zero; or any other such method. This may help determine whether all of the subjob course prerequisites have been analyzed. If the index value p is greater than the total number of subjob course prerequisites, the server may proceed to step 130″, increment m, and move on to analysis of the next subjob. Otherwise, the server may proceed to step 124″.

In an implementation, at step 124″ an analogous course finder may determine whether user has completed the subjob course prerequisite. This may be performed by the analogous course finder determining whether the subjob course prerequisite is corresponds to a course in the previously obtained courses database. If the user has completed the subjob course prerequisite, the server may proceed to step 128″. If not, the server may proceed to step 126″.

In an implementation, at step 126″ a career server may calculate the years that would have to be spent to fulfill the subjob course prerequisite. This may be determined by the server referring to e.g. a lookup table in the career path database, or by the server referring to metadata associated with the subjob course prerequisite, or by any other appropriate manner. The calculation may involve subtracting any years previously spent by the user on the subjob course prerequisite where the subjob course prerequisite was not completed, as determined by e.g. user information provided to the server as part of a request to determine a career path.

In an implementation, at step 128″ a career server may increment p, and the next subjob course prerequisite may be analyzed.

In an implementation, at step 130″ a career server may increment m, and the next subjob may be analyzed.

In an implementation, at step 132″ a career server may calculate an expected lifetime income for each of the n career paths. This may be done in any appropriate manner. For example, a formula for calculating expected lifetime income might be the formula depicted in FIG. 1C, where the salary of each subjob in a career path is multiplied by the expected number of years spent on that subjob, summed over all the subjobs, and the salary of the target job is multiplied by an estimated retirement age (e.g. 65, or an estimate based on user input) minus the estimated age of the user when the target job is achieved (based on e.g. user input as to current age and the number of years spent on subjobs and course prerequisites). The expected number of years spent on a subjob may be determined by e.g. reference to a lookup table in the career path database.

In an implementation, at step 134″ a career server may select a best career path based on the expected lifetime income, or a top 3 best career paths, of any number of the highest estimated expected lifetime income career paths.

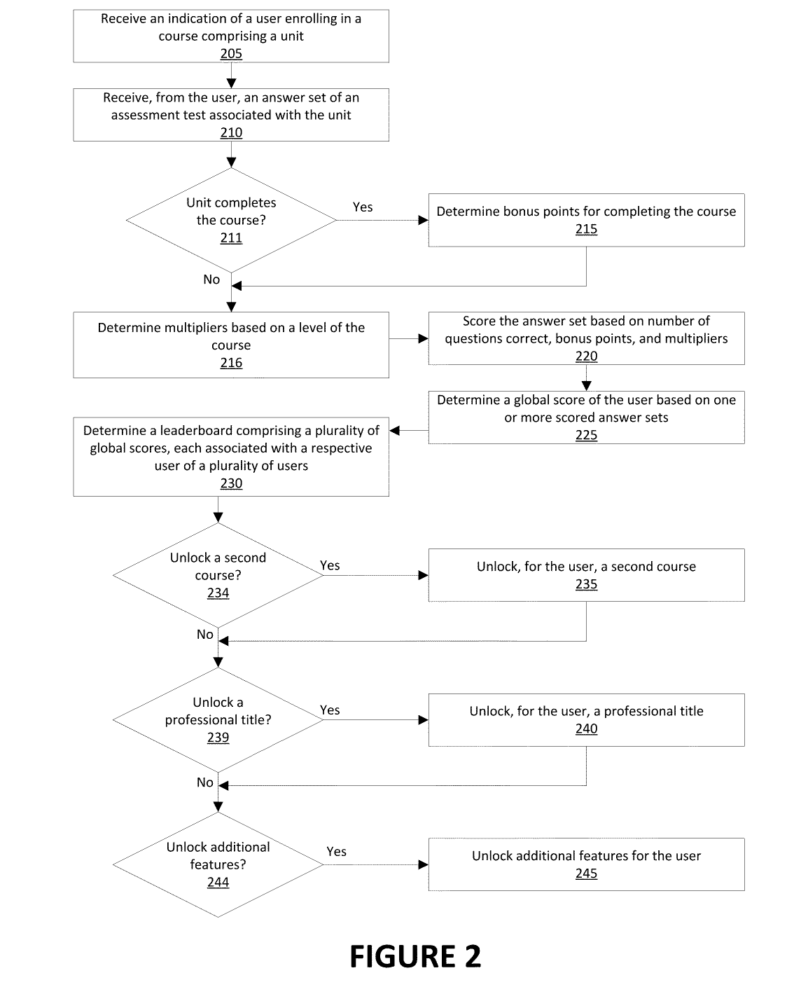

FIG. 2 is a flowchart of an implementation of a method of determining a leaderboard of users for the portal, and/or for providing other gamification features. In brief overview, at step 205, the server may receive an indication of a user enrolling in a course comprising a unit. At step 210, the server may receive, from the user, an answer set of an assessment test associated with the unit. At step 211, the server may determine whether the unit completes the course. If the unit does complete the course, at step 215, the server may determine bonus points for completing the course. At step 216, the server may determine multipliers based on a level of the course. At step 220, the server may score the answer set based on number of questions correct, bonus points, and multipliers. At step 225, the server may determine a global score of the user based on one or more scored answer sets. At step 230, the server may determine a leaderboard comprising a plurality of global scores, each associated with a respective user of a plurality of users. At step 234, the server determines whether to unlock a second course. If so, at step 235, the server may unlock, for the user, a second course. At step 239, the server determines whether to unlock a professional title. If so, at step 240, the server may unlock, for the user, a professional. At step 244, the server determines whether to unlock additional features. At step 245, the server may unlock additional features for the user.

Still referring to FIG. 2, and in more detail, at step 205, the server may receive an indication of a user enrolling in a course comprising a unit. The user may enrolls in a course on the platform to update his or her skill. A course may upgrade one or more skills. A course may belong to one or more skill groups. For instance, a skill group “Computer Science” may include courses called “Introduction to Programming,” “Data structures,” “Algorithms” and so on. A course may include one or more units. Each unit may be associated with an assessment test. In some implementations, a course may be associated with an assessment test. An assessment test may test whether a user has mastered materials in the associated unit and/or course. The assessment test may comprise a set of questions, such as multiple choice questions. For instance, a question may be “When will the universe end?” and the answers may be (A) It won't, (B) The universe will expand indefinitely, (C) Wait for the collapse of the universe, and (D) In forty-two minutes. The assessment test may be timed and administered to a user via a computing device.

At step 210, the server may receive, from the user, an answer set of an assessment test associated with the unit. The assessment test may be completed online by a user on a computing device connected to a network, for instance via a web browser or an app on a mobile device. The answer set may include one or more answers to the assessment test associated with the unit. For instance, the answer set may comprise a plurality of multiple choice answers. The server may determine or obtain base points associated with the assessment test associated with the answer set. The base points may be stored in a database that stores course information.

At step 211, the server may determine whether the unit completes the course. The course may comprise a plurality of units, and the user may have already completed the assessment test for all of the plurality of units except for the unit corresponding to the received answer set. For instance, a course may have three units, two of which the user has already completed the assessment tests. In some implementations where a course comprises a plurality of units, the server may determine that the unit is the last unit of the course. For instance, a unit may include three units, two of which the user has completed already. The server may receive an answer set of the assessment test, and determine that the assessment test corresponds to the third unit in the course, and determine bonus points associated with completing the course. The bonus points may be added to the base points. The third unit may correspond to the received answer set. If the unit does complete the course, the server may continue to step 215. Otherwise, the server may continue to step 216.

At step 215, the server may determine bonus points for completing the course. The bonus points may be stored in the available courses database. The bonus points may correspond to the course. The bonus points may be proportional to the number of units in the course. For instance, bonus points may equal to the number of units in the course multiplied by a factor. The factor may be between, for instance, 0.1 to 100. The server may continue to step 216.

At step 216, the server may determine a multiplier associated with the level of the course. A course may be assigned to one of many levels. For instance, a course called “Introduction to Programming” may be assigned to level one or beginner level, and a course called “Artificial Intelligence” may be assigned to level two or intermediate level. Each level may be associated with a multiplier. For instance, beginner level courses may be associated with a multiplier of 1.0, intermediate level courses may be associated with a multiplier of 2.0, and advanced level courses may be associated with a multiplier of 3.0. A multiplier may be any value. For instance, a multiplier may be between a range of 0 to 100.

At step 220, the server may score the answer set based on number of questions correct, bonus points, and multipliers. The server may go through each of the answers provided in the answer set and compare it to an answer sheet associated with the assessment test. The answer sheet may be stored with the assessment test in the database that stores course information. In some implementations, the server may score may increase the score for each correct answer in the answer set. In some implementations, the server may not penalize the score for each wrong answer in the answer set. In some implementations, each question may be worth the same number of points, for instance one point. In other implementations, each question may be worth different number of points. The server may score add any bonus points and/or multiply the score by the multiplier associated with the level of the course. In some implementations, each assessment test may be associated with a threshold, such that if the user has scored above the threshold, the user is considered to have mastered the unit (e.g. the skill associated with the unit), but if the user scored below the threshold, the user is considered to not have mastered the unit. In some implementations, the score for the answer set may be calculated in real-time.

At step 225, the server may determine a global score of the user based on one or more scored answer sets. The global score may be associate with the user. In some implementations, the global score may be a summation of a plurality of scores of answer sets each associated with a respective unit. For instance, the user may have completed assessment tests for three units for the course “Introduction to Programming,” for one unit for a course “Astrophysics,” and for seven units for a course in “Pillow Fighting Techniques.” The scores for each assessment test may be used to determine the global score. The global score may be equal to the overall points earned for all the courses (and/or units) that the user has completed.

In some implementations, the global score may be a weighted sum of a plurality of scores of answer sets. The weights may be determined by, for instance, time since the answer set was submitted, or time since the assessment test was taken by the user. In some implementations, each score of answer sets may have a decay value such that it slowly decreases over time. In some implementations, a user may retake an assessment test to increase the score associated with the assessment test. In some implementations, the assessment test that the user can retake may be a refresher test that may be shorter than an assessment test that the user took first time. In some implementations, the global score may be calculated in real-time.

At step 230, the server may determine a leaderboard comprising a plurality of global scores, each associated with a respective user of a plurality of users. In some implementations, the global score associated with the user may be pushed to a leaderboard on the platform or on a website associated with the platform. The user points may display a rankings of global scores and associated users in a descending order. The leaderboard may be shown for a certain skill group, country, course, and unit.

The server may determine a leaderboard by ranking the plurality of scores. The users of the plurality of users may be ranked based on the rank of the respective global score of the plurality of global scores. In some implementations, the server may partially rank the plurality of global scores. For instance, the server may only need the top five global scores. In some implementations, the server may only need to rank the leaderboard if the server receives an indication of a change in a global score. In some implementations, the server may already have an initial ranking of plurality of global scores and re-rank the plurality of global scores based on a change in a global score. In some implementations, the server may periodically rank or re-rank the leaderboard. In some implementations, the leaderboard may be determined in real-time.

In some implementations, the server may determine a plurality of leaderboards. For instance, one leaderboard may be an overall leaderboard for the entire platform, and another leaderboard may be for a skill group such as Computer Programming or Pillow Fighting. In some implementations, each geographic region may correspond to a respective leaderboard. For instance, one leaderboard may be for United States, and another leaderboard may be for Germany. In some implementations, each course and/or unit may correspond to a respective leaderboard. In some implementations, a first user may have his or her own leaderboard, which only includes global scores associated with one or more second users, such that the first user may be associated with the second users via social networking sites and/or via the platform. In some implementations, a leaderboard may be filtered via skill groups, geographic region, course, unit, and/or list of second users associated with the user via a social networking site. For instance, the plurality of global scores may be sorted by highest for the course, unit, country, or skill group.

At step 234, the server determines whether to unlock a second course. In some implementations, the server may unlock the second course if the completed course completes prerequisites of the second course. In some implementations, the server may unlock the second course if the global score of the user is a minimum score limit associated with the second course. In some implementations, the second course may be associated with a higher level than a first course that was completed by the user. In some implementations, each course may be associated with a minimum global score for the user to have in order to enroll in the respective course. Some introductory courses may not have a minimum global score or have a really low global score, such as between one to a thousand. Advanced courses may be associated with a higher minimum global score, for instance over nine thousand. In some implementations, the global score (also referred to as total accumulated points) may be used to unlock more courses. Users may redeem points for free courses on the site. For instance, an “Introduction to Digital Photography” course may be redeemed for nine thousand points. In some instances, the courses that may be redeemed may be purchased by the user if the user does not have enough points or if the user does not wish to redeem points. If the server determines to unlock a second course, the server may continue to step 235. Otherwise, the server may continue to step 239.

At step 235, the server may unlock, for the user, a second course. Unlocking the second course may allow the user to enroll in the second course. In some implementations, the unlocked second course may be added to a news feed of the user. In some implementations, the second course may be unlocked such that the user may pay to enroll for the second course. The server may continue to step 239.

At step 240, the server determines whether to unlock, for the user, a professional title. In some implementations, the server may determine whether to unlock the professional title based on a skill group associated with the course. For instance, if a user has completed a predefined number of courses and/or required courses in the skill group “Computer Science,” the user may have access to the professional title “Software Engineer.” In another instance, a user with at least five thousand points in a photography skill group can unlock a professional title such as “DSLR Expert” or other professional titles according to course skill groups. The user may have access to one or more professional titles. The server may receive a request from a user to specify one of the unlocked professional titles in the user's talent profile. In some implementations, only one professional titles may be specified in a talent profile. In other implementations, a plurality of professional titles may be specified in a talent profile. In some implementations, users get access to job titles (such as professional titles) only if badges (which are granted to users for mastering skills, completing courses, or taking assessment tests) are unlocked. The unlocking of badges, professional titles may be part of gamification. If the server determines to unlock the second course, the server may continue to step 235. Otherwise, the server may continue to step 239.

At step 240, the server may unlock for the user, a professional title. In some implementations, the unlocked professional title may be added to a news feed of the user. In some implementations, a badge may be unlocked for the user, which further unlocks the professional title. The server may continue to step 244.

At step 245, the server may determine whether to unlock additional features. In some implementations, if the global score of a user is below a threshold (set by the platform), the user may only use certain features of the platform, such as a website for jobs and courses. In some implementations, exceeding the threshold may unlock features such as recommended jobs and career paths, trending jobs, leaderboards, recommended courses to take, etc. In some implementations, if the global score of a user is below a minimum threshold, the server may put the user's account on hold until they complete recommended courses or courses of their choice. For instance, if the user has less than one hundred points, the server may require the user to complete a recommended course before gaining access to the website for jobs.

At step 245, the server may unlock additional features for the user responsive to the global score exceeding a threshold. In some implementations, the additional features may be premium features. In some implementations, the server may unlock one or more badges for the user for exceeding the threshold.

FIG. 3A is a flowchart of an implementation of a method of determining trending skills. In brief overview, at step 305, the server may receive an indication to update trending skills. At step 310, the server may determine a list of skills based on a scan of a first website and a plurality of websites, the first website comprising an available jobs database, each job in the available jobs database comprising a respective skill. At step 320, the server may determine, for a skill in the list of skills, a number of instances on the first website for each geographic location. At step 330, the server may determine, for the skill in the list of skills, an average number of instances for each geographic location in the plurality of websites. At step 335, the server may determine, for the skill in the list of skills, a total score for each geographic location, by a weighted sum of the number of instances and the average number of instances. At step 336, the server may determine whether there are additional skills in the list of skills. At step 340, the server may rank, for each geographic location, the list of skills based on the respective total score for each geographic location.

Still referring to FIG. 3A, and in more detail, at step 305, the server may receive an indication to update trending skills. In some implementations, the server may update trending skills based on receiving a request from a user to display trending skills. In some implementations, the server may dynamically change the trends of skills. In some implementations, the server may periodically update the trending skills. For instance, the server may update the trending skills every day, week, month, etc. The periodicity of when the server updates trending skills may be set to between a day to a month. The trending skills system on the platform may display the most in-demand skills in the job market, for instance the available jobs database. Trending skills may comprise a list of skills that are included greatest number of job openings. Trending skills may be associated with or filtered by one or more of a geographic region, job, fields of study, educational background, etc. For instance, the server may receive an indication to update a first set of trending skills for United States, and a second set of trending skills for Mexico. In another instance, the server may receive an indication to update a first set of trending skills for Computer Science majors, and a second set of trending skills for English majors. The aim of the trending skills display is to keep users informed about skills that are trending in the job market at that moment.

At step 310, the server may determine a list of skills based on a scan of a first website and a plurality of websites, the first website comprising an available jobs database, each job in the available jobs database comprising a respective skill. In some implementations, the website may be part of the platform. The server may determine the list of skills via an API or provide an API that may be used to determine the list of skills. The plurality of websites may include websites that comprise job openings. In some implementations, the server may access one or more additional job databases associated with one of the plurality of websites. In some implementations, the server may access one or more jobs from the plurality of websites via a web crawler, a scraper, or a search engine. The server may determine the list of skills by extracting skills associated with job openings from the first website and the plurality of websites. The trending skills API makes use of the data on the first website and the platform as well as data found openly on the internet by tapping into job feeds. Job feeds may include internet databases and other websites that list job openings. The plurality of websites may be pre-listed, pre-set, or predefined on the server. In some implementations, the list of skills may be manually updated or predefined. In some implementations, when an employer adds or updates an entry in the available jobs database, the server may update a predefined list of skills. Although described as websites, in some implementations, the server may scan a database, index, flat file, or any other type and form of data storage.

At step 320, the server may determine, for a skill, a number of instances on the first website for each geographic location. Steps 320 to 335 may be performed for each skill in the list of skills. The server may search the first website, the available jobs database, and any servers or databases of the platform. The server determines, for the skill in the list of skills, the number of instances founds in the available jobs database. The server may search for jobs (such as job openings) and courses (including units) that are tagged with skills field. A skill may be “Digital Marketing” and the server may find thirty jobs that include this skill. In some implementation, the server may search for each instance based on each geographic region. The geographic region may be country, state, or any other level of geography. For instance, the server may search the first website for a first number of instances that the skill is found in job openings in the United States; the server may also search the first website for a second number of instances that the skill is found in job openings in Mexico. In some implementations, the API scans the first website and/or the platform for each skill (also referred to as the specific skill), and the API only counts an instance once per job page to avoid duplication. Job page may be one entry in the available jobs database, or one webpage in the first website. In some implementations, a job page (such as a job opening or a job entry) may only include a limited number of main skills, and the server may count a job page only if the specific skill is one of the main skills. For instance, an entry in the available jobs database may include three main skills and four other skills, and the server may count the job if one of the three main skills is the skill for which the server is counting the number of instances. In some implementations, a course may be associated with a limited number of main skills, and the server may count the course if one of its main skills is the skill for which the server is counting the number of instances. In some implementations, the API performs a blanket search within the first website for the skills.

At step 330, the server may determine, for each skill in the list of skills, an average number of instances for each geographic location in the plurality of websites. Jobs on other platforms (such as plurality of websites) also have skills in their job descriptions. The API does a blanket search on country specific job feeds over the internet for the skills present on the website (such as plurality of websites). On the internet, the API taps into feeds that are pre-set in the system (such as the platform, and/or the server) to run checks on. The server may go through a blanket search for each skill (such as keywords associated with each skill) on country-specific job feeds, and may count one instance of the skill per page. In some implementations, the plurality of websites may comprise a pre-set number of sources (such as job feeds). In such implementations, the average number of instances may be determined by determining a sum of instances in all of the plurality of websites, and dividing the sum of instances by the number of websites in the plurality of websites. For instance, there may be three different websites that list job openings, and the sum of instances of listed jobs with a specific skill (for each skill in the list of skills) may be thirty. In that instance, the average number of instances for the specific skill will be ten. In some implementations, the average number of instances may be determined for a geographic location or for each geographic location. For instance, the server may determine an average number of instances in the United States for the skill “Patent Prosecution” in the plurality of websites. In some implementations, the average number of instances may be determined by dividing by number of websites from the plurality of websites that includes the specific skill. For instance, for the skill “Patent Prosecution,” the server may search for that skill in three websites, but only two of the websites may have any openings with that skill. In that instance, the server may divide the total number of jobs from the two websites by two. In some implementations, the average number of instances may be determined based on the number of websites in the plurality of websites. For instance, the average number of instances may be determined by dividing a total number of instances by a factorial of the number of websites in the plurality of websites.

At step 335, the server may determine, for the skill in the list of skills, a total score for each geographic location, by a weighted sum of the number of instances and the average number of instances. The API may count the total number of instances on the first websites (such as the platform) and assign one point to each instance. The total number of instances or a final summation of these instances may be multiplied by a correctional factor. In some implementations, the correctional factor may be, for instance, between 0.01 and 0.99. For instance, the correctional factor may be 0.7. In some implementations, the correctional factor may be pre-defined or may be formulated by the server. The API may assign points to a blanket search within the first website with a formula. The formula may be, total number of instances on the first website per geographic location multiplied by a correctional factor (such as 0.7).

In some implementations, the server may determine a summation of the average number of instances for each geographic location in the plurality of websites. The summation may be for a specific geographic location for a specific skill in the list of skills. On the feeds and open internet search for keywords, the system may count a summation of total instances on each unique country's specific website, divided by the total number of country-specific websites where the keyword is found. The summation is multiplied by another correctional factor which may be between 0.01 and 0.99. For instance, the correctional factor may be 0.3. The sum of correctional factors may be one. The correctional factor may account for high number of keyword instances found online and adjusted to create a more realistic result. The correctional factors may be weights for the weighted sum. In some implementations, as more and more new websites are added to the plurality of websites (such as to the external search feeds that the system or the platform has to tap to) the correctional factor can be adjusted. In some implementations, a factorial division can be placed on the instance searches to yield realistic results. For instance, the average number of instances may comprise dividing by the factorial of the number of websites in the plurality of websites. In some implementations, the API may assign a correctional factor to a final result from the blanket search on the plurality of websites. The final result may be a summation of the total number of instances on a single external country specific website, divided by total number of country specific websites where the keyword (associated with the skill) is found. The correlation may be added (for multiplication) as a correctional factor.

The weighted sum may be determined for each skill, for each geographic location. For instance, the weighted sum may be for United States, for the skill “Digital Marketing.” The two numbers of above (the numbers that were each multiplied by the correctional factors) may be added to calculate the total point score. The total score (corresponding to each skill) may be used to determine the skills that are trending in the market and can be filtered geographically.

At step 336, the server may determine whether there are additional skills in the list of skills. The server may iterate through (or loop through) each skill in the list of skills. If there are additional skills in the list of skills for which the server has not performed the steps 320 to 335, the server may pick the next skill in the list of skills and continue to step 320. Otherwise, if the server has performed for the steps 320 to 335 on each skill in the list of skills, the server may continue to step 340.

At step 340, the server may rank, for each geographic location, the list of skills based on the respective total score for each geographic location. The total point score may be used to determine the position of each skill in the trending skills list (or the list of skills). In some implementations, the score may be used to rank or partially rank the skills in the trending skills list. The server may not display the score of each skill to a user; the assigned points cannot be viewed by users and may only be for operational use by the API. The trending skills list may change based on a user's pre-defined location. In some implementations, a user may specify or choose a geographic location. For instance, a user may specify California, and the server may determine the trending skills list for California. The trending skills may be displayed (such as on the first website, at the user's computing device) on a leaderboard in descending order, based on location. Points may be not be visible to users and may be for operational purposes only.

In some implementations, each skill in the trending skills may be automatically linked to course (such as a web page of the course) and/or jobs related to that trending skill (such as a web page for job opening that lists the skill as a main skill). As the order of the trending skills may change, the links (such as buttons) next to each skill will move and change with the trending skills.

Referring to FIG. 3B in a general overview, FIG. 3B is a depiction of an implementation of a system 350 for generating a course selection list.

In an implementation, system 350 comprises a career server 352. The career server 352 may be a server used to manage an education portal, or may be a server used to manage a job finding portal, or may be a server used to manage a course finding portal or may be any other kind of server. The career server 352 may be one or more computing devices, such as rackmount servers, desktop servers, a server farm, a cloud or a cluster of servers, or any other such devices. In some implementations, career server 352 may comprise one or more virtual machines executed by one or more physical machines. Tasks may be allocated among a plurality of servers by an application, service, daemon, routine, or other executable logic for task allocation. The career server 352 may include a processor 354 and memory 356.

In some implementations, career server 352 comprises a profiler 358. The profiler 358 may process information to form a profile, or may maintain a profile by storing and updating it. For example, the profiler 358 may process a textual description of a history of a user comprising obtained courses and jobs and store the data on the career server 152. The profiler may update the stored data as new information is received. The profiler 358 may be a library, application programming interface (API), set of scripts, or any other code suitable for such processing and maintaining.

In an implementation, the profiler 358 may perform tasks as part of a method of gamification of an education portal. The profiler 358 may determine points to be awarded to a user based on, e.g., completion of an assessment test. The profiler 358 may tally and score a global score of a user, or unlock courses available on an education portal such as, e.g. the career server 352, or may perform other appropriate tasks related to carrying out a method of gamification of an education portal.

In an implementation, the career server 352 comprises a database of available courses 360. This database may be stored on the career server 352, or may be hosted elsewhere but be accessible by the career server 352 via e.g. a network connection or via e.g. a USB connection to an external hard drive, or via any other appropriate means. The available courses database 360 may be updated by the career server 352 periodically, or may be updated manually, or may be updated dynamically such as, for example, whenever a request to generate a course selection list is received by the career server 152. Updating the available course database may involve e.g. accessing an external available jobs database and downloading a list of available jobs, possibly along with any metadata concerning such available jobs.

In some implementations, the career server 352 may comprise a previously obtained courses database 362. This may comprise course history information pertaining to specific users. The course history information may have been created by the profiler 358 processing user information.

As discussed above, in some implementations, course listings may be obtained from third parties with varying labeling standards. To normalize these listings or fit them into a predetermined classification scheme, in some implementations, the career server 352 may comprise an analogous course finder 364. The analogous course finder 364 may identify, for previously obtained courses, corresponding predetermined courses from a known course database 366. For example, a previously obtained course may be “java 101.” The analogous course finder 364 may identify a corresponding predetermined course from the known course database 366 such as “introduction to computer science,” or “java 101.” The corresponding predetermined courses may correspond based on course information metadata, or by association in a lookup table, or by a determination by a computer learning algorithm, or in any other manner. The analogous course finder 364 may be a library, application programming interface (API), set of scripts, or any other code that matches previously obtained courses and corresponding predetermined courses. The analogous course finder 364 may also identify skills associated with the predetermined courses from the known courses database. The skills may be identified based on course information metadata, or by association in a lookup table, or in any other appropriate manner. The identified skills may be added to a profile for a user by the analogous course finder 364. Alternatively, the identified skills may be added to a profile for a user by the profiler 358. The analogous course finder 364 may also classify retrieved identification of an available course from e.g. the available course database 360 with a predetermined classification. For example, for example, a retrieved identification of “java 101” from the course database may be classified as a computer science course. The predetermined classifications may be associated with one or more skills. The skills may comprise any kind of skill, such as, for example, expertise in a computer programming language, fluency in a language, artistic skill, time management skill, marketing skill, or any kind of skill.

In an implementation, the career server 352 may comprise an obtained jobs database 370. This may comprise job history information pertaining to specific users. The job history information may have been created by the profiler 358 processing user information.

In an implementation, the career server 352 comprises an available jobs database 372. This database may be stored on the career server 352, or may be hosted elsewhere but be accessible by the career server 352 via e.g. a network connection or via e.g. a USB connection to an external hard drive, or via any other appropriate means. The available jobs database 372 may be updated by the career server 352 periodically, or may be updated manually, or may be updated dynamically such as, for example, whenever a request to generate a course selection list is received by the career server 152. Updating the available jobs database 372 may involve e.g. accessing an external available jobs database and downloading a list of available jobs, along with any metadata concerning such available jobs.

As with third-party course listings, third-party job listings may have varying labeling standards for the same jobs. Accordingly, to normalize job listings, in some implementations, the career server 352 comprises an analogous job finder 374. The analogous job finder 374 may identify, for previously obtained jobs stored in e.g. the previously obtained jobs database 370, a corresponding predetermined job in a known jobs database 376. For example, a previously obtained job may be an entry level advertising position such as “advertising firm intern”. The analogous job finder 374 may identify a corresponding predetermined job such as, e.g., “entry level advertiser” or “junior advertising associate” from the known jobs database 376. The analogous job finder 374 may also identify skills associated with the predetermined jobs from the known jobs database 376. The skills may be identified based on job information metadata, or by association in a lookup table, or in any other appropriate manner. The identified skills may be added to a profile for a user by the analogous job finder 374. Alternatively, the identified skills may be added to a profile for a user by the profiler 358. The analogous course finder 364 may also classify retrieved identification of an available job from e.g. the available jobs database 372 with a predetermined classification. For example, a retrieved identification of “entry level computer programmer” from the job database may be classified as a computer science job. The predetermined classifications may be associated with one or more skills. The skills may comprise any kind of skill, such as, for example, expertise in a computer programming language, fluency in a language, artistic skill, time management skill, marketing skill, or any kind of skill.

In an implementation, the career server 352 comprises a skill matcher 380. The skill matcher 380 may be a library, application programming interface (API), or set of scripts. The skill matcher 380 may determine a subset of skills common to the profile for the user and each available job in the available jobs database. The skill matcher may further identify a first available job associated with at least one skill of the subset of skills and associated with a second at least one skill not identified in the profile of the user. For example, a user profile may include graphic design skills and digital advertising skills. An available job, for example, a contract to design an online banner ad, may be associated with the same set of skills as well as social media skills that the user profile does not have. The user may have some, but not all, of the skills associated with the available job. The skill matcher 380 may help fill the gap in the user's skill set. The skill matcher 380 may identify an available course from e.g. available courses database 360 as being associated with the missing skill. In the example above, the skill matcher 380 may identify am available course associated with social media skills. The skill matcher 380 may add this course to a list of relevant courses for the user. The skill matcher 380 may fill skill gaps between a user and jobs in the available jobs database 372, or between jobs such as target jobs or subjobs in e.g. the career path database 390, discussed below, or between a user and other jobs.

In an implementation, career server 352 may comprise career path database 390. A career path database 390 may comprise one or more career paths 392. The career paths 392 may be predetermined. A career path may be a set of jobs including a target job and at least one subjob, or a target job identifier 394 and at least one subjob identifier 396. The target job and the subjobs may be related in that the subjobs may lead to the target job. For example, the subjob may be associated with prerequisites of the target jobs. The subjobs may be prerequisite work experiences required before a target job can be obtained. The subjobs may also be learning experiences that teach skill prerequisites of the target job. The subjobs may also lead to the target jobs in other ways, for example, people with the subjobs may be commonly promoted to the target job, e.g. an associate position at a law firm may be a subjob for a partner position target job.

In some implementations, career server 352 may comprise a scanner 398. The scanner 398 may be a library, application programming interface (API), set of scripts, or any other code that scans websites, databases, or any other source of information to e.g. determine whether and which skills are trending. The scanner 398 may do so by, e.g., the method depicted in FIG. 3A, or by any other appropriate method. The scanner 398 may rank a list of trending skills. The scanner 398 may rank a list of trending skills for one or more geographic locations.

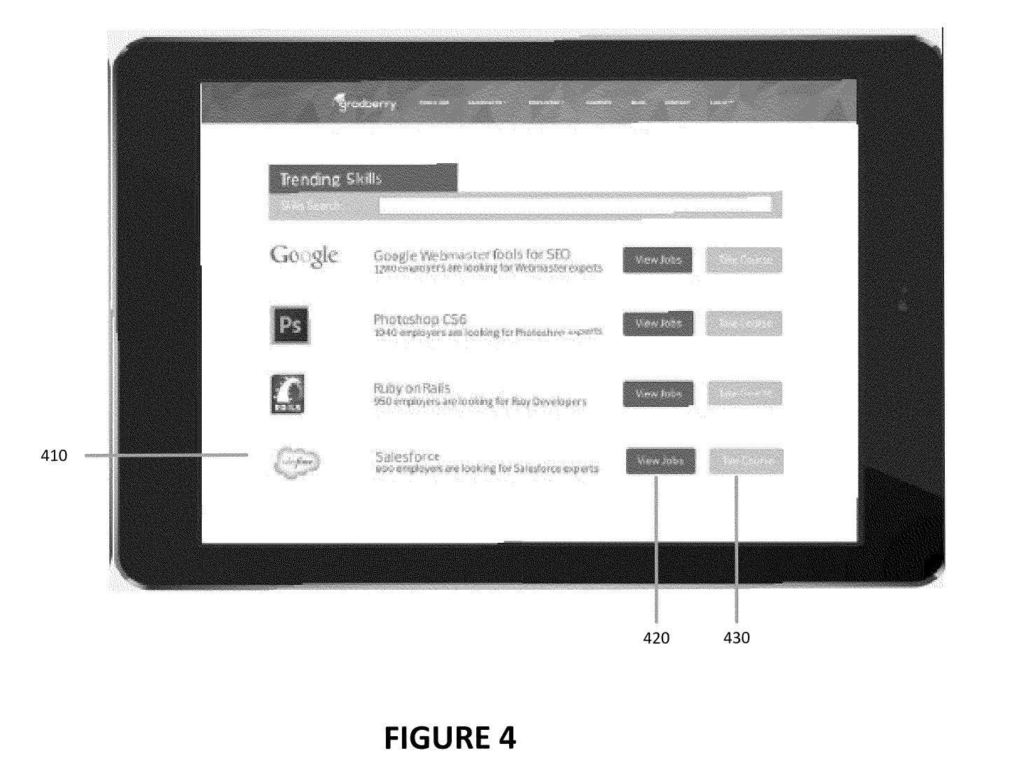

FIG. 4 depicts an embodiment of an interface provided on a computing device for trending skills. The interface may be provided on a computing device such as a laptop, desktop, tablet, smartphone, any other computing device that comprises a network interface. The interface may be displayed or rendered via a web browser or an application on the computing device. The interface may provide trending skills as determined by the method described in relation to FIG. 3. The interface may comprise a list of skills. Each skill 410 may be displayed with the name of the skill, a brief description of the skill, and an icon. Each skill may also be displayed with a link or a button 420 for viewing one or more jobs that require the skill. Each skill 410 may also be displayed with a link or a button 430 for viewing one or more courses that are associated with the skill.

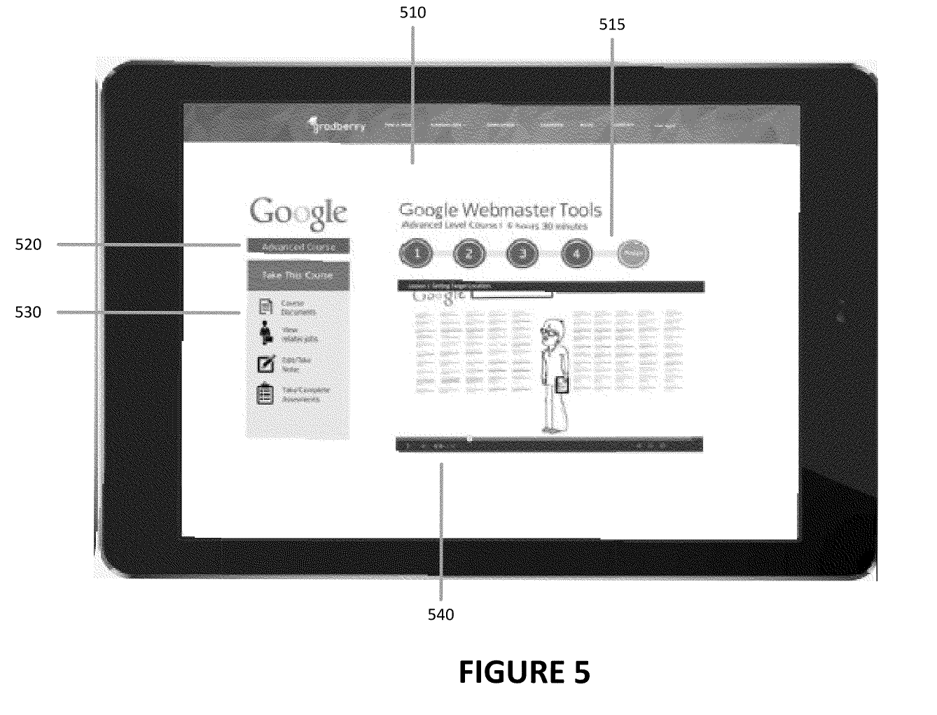

FIG. 5 depicts an embodiment of an interface provided on a computing device for a course. The interface may comprise a name 510 of the course and a level of the course. A course may comprise a plurality of units. The interface may display the plurality of units 515. The interface may display which of the units have already been completed by a user viewing the interface via the computing device. The interface may comprise a total time required to complete the course, time remaining to complete the course, time to complete a unit (such as next uncompleted unit in a sequence of unit in the course), or any other time requirement associated with the course. The interface may further comprise a logo and a level of the course 520. The interface may also comprise different options 530 that the user may take. For instance, the user may select an option to take the course (or a unit of the course), access course documents, view related jobs (jobs that require the skills taught by the course), edit or take notes, and take or complete assessments associated with the course (or a unit of the course). The interface may further comprise video, audio, documents, and other interactive media 540 that teaches the course 540 to the user on the computing device.

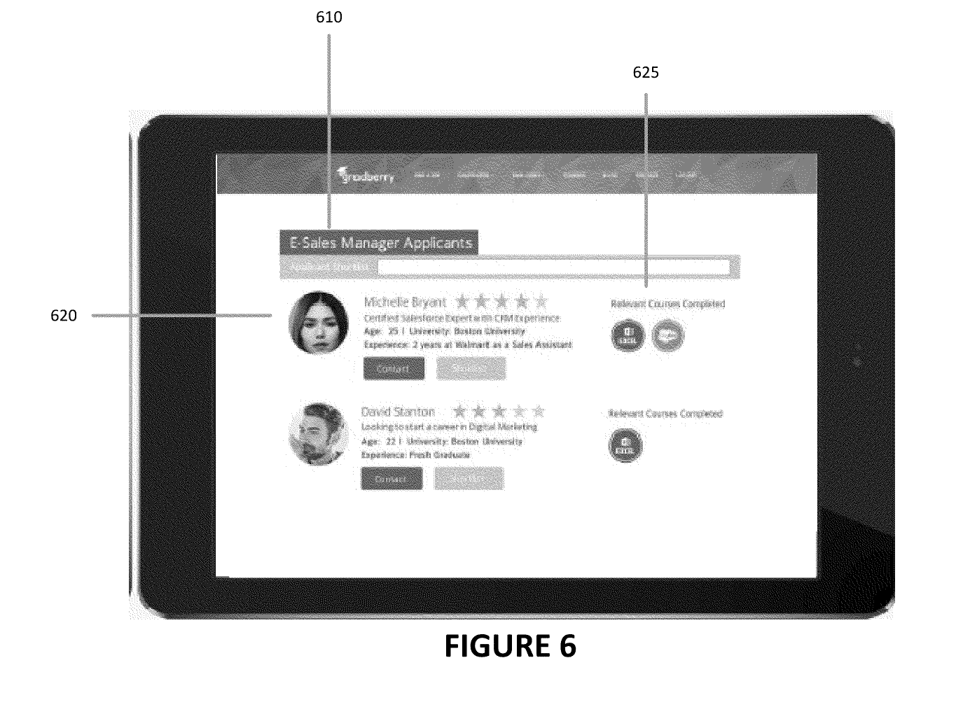

FIG. 6 depicts an embodiment of an interface provided on a computing device for employers to view applicants to job openings. The interface may comprise a title of a job opening and/or an indication that the page includes applicants for the job opening. The interface may further comprise an indication of an applicant shortlist, which may be a list of applicants who best qualify or match with the job opening. The interface may comprise one or more applicants 620 who best match with the job opening. Applicant names, the quality of the match (determined by matching the user's profile with the job or the skills required for the job) and other profile information may be displayed. For instance, the most recent job title, age, an educational background may be displayed with a respective user. The interface may further comprise one or more relevant courses completed by each respective user. The relevant courses may be required skills or courses that teach the required skills of the job opening.

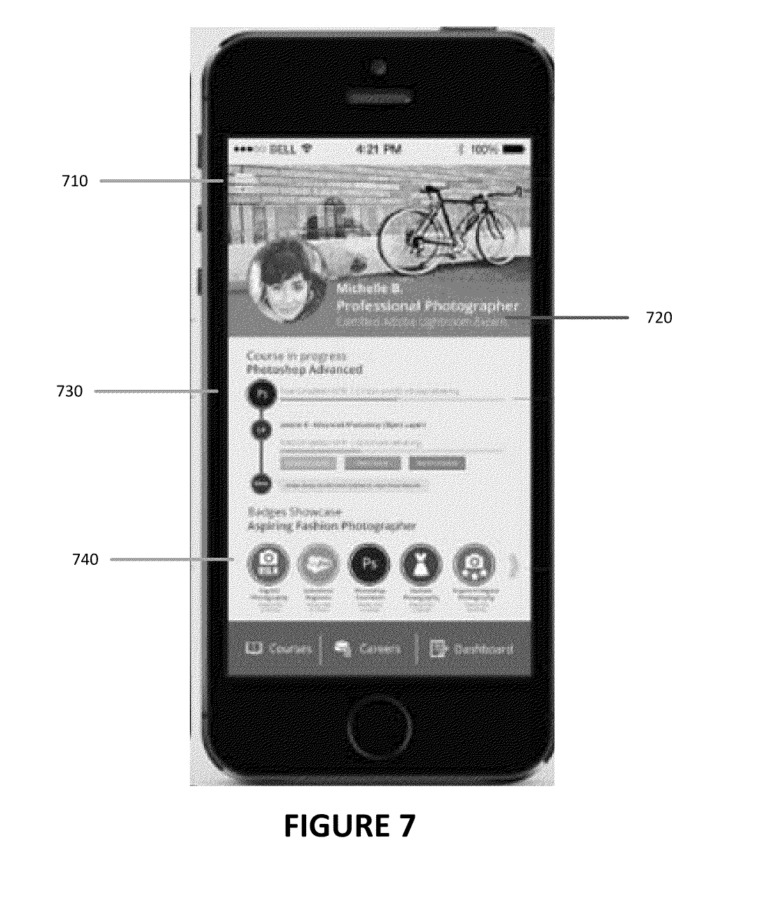

FIG. 7 depicts an embodiment of an interface provided on a computing device of a user profile. The interface may allow the user to access the main menu 710. In some implementations, the main menu may be tucked away so the user can seamlessly browse through rich content. In some implementations, the rich content may include video, audio, text, and other interactive elements and media. The interface may include a profile image, name of the user, and a profile title 720. The profile title 720 may be unlocked by the user via the method described in relation to FIG. 2. A user may be able to unlock new profile titles by completing courses or a set of courses and display one or more profiles titles on his or her talent profile. The interface may comprise one or more courses that are in progress 730. For instance, the user may be in progress of taking a second unit of a course that include three units. The course in progress may also show, for instance, a progress bar or indicator for each unit. For instance, if a unit is taught via a video, the progress bar may indicate how far along the user on the computing device has watched the video. In some implementations, the interface may allow the user to navigate through the course the user is currently taking. For instance, the interface may allow the user to swipe up or down through the courses. The interface may allow the user to learn on the go (such as on a mobile device) with the ability to watch video content on an application and to take a course assessment test. The interface further include one or more badges 740 the user has unlocked. Badges may be unlock by the user's total number of points exceeding some number of points, completing a course and/or an assessment test, or unlocking a profile title. In some implementations, the interface allows the user to showcase a predetermined number of badges (for instance, any number of badges between one to one hundred) as well as managing the badges from within the app.

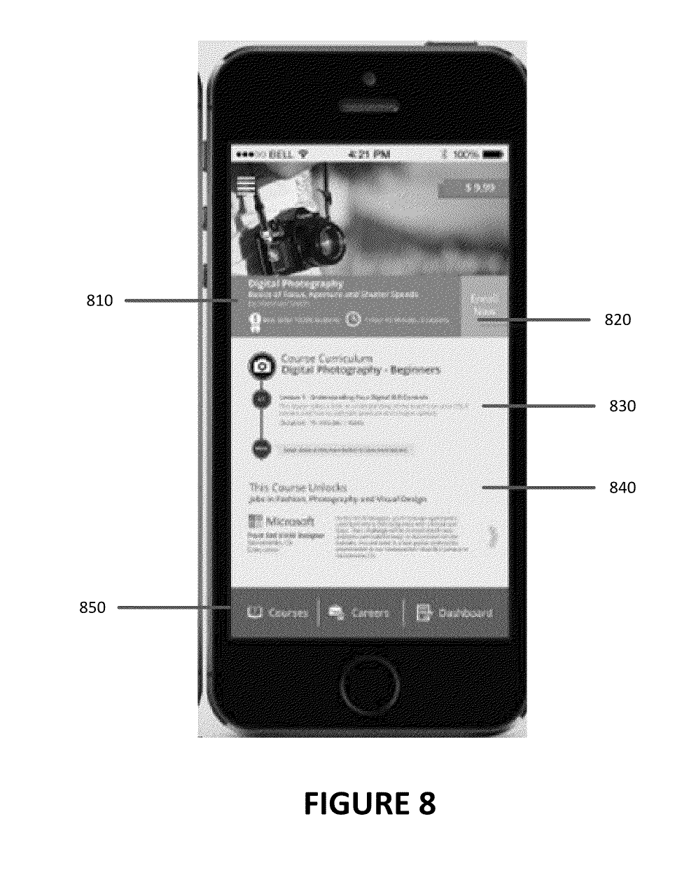

FIG. 8 depicts an embodiment of an interface provided on a computing device for viewing courses. The interface may include a name and description of the course 810 as well as level of the course and time required to finish the course. The interface may further include a button to enroll in the course 820. In some implementations, the button to enroll may only be displayed on the interface if a user on the computing device is not already enrolled on the course. The interface may allow the user to get all the main course information at a glance and a one click enroll system. The interface may also include information for the one or more units 830 of the course. In some implementations, the interface may allow the user to view the course curriculum (via for instance, scrolling up and down through the course curriculum) to see all the lessons included in the course. The lessons may also correspond to units of the course. The interface may further comprise information regarding unlocks 840 for completing the course, such as additional courses, jobs, badges, and profile titles available to the user upon completing the course. A match algorithm may select jobs that will be displayed and unlocked from completing the course. In some implementations, more than one jobs may be unlocked, and the user may be allowed scroll through more jobs (via, for instance, scrolling left and right). The interface may further include one or more menu buttons and navigational buttons 850.

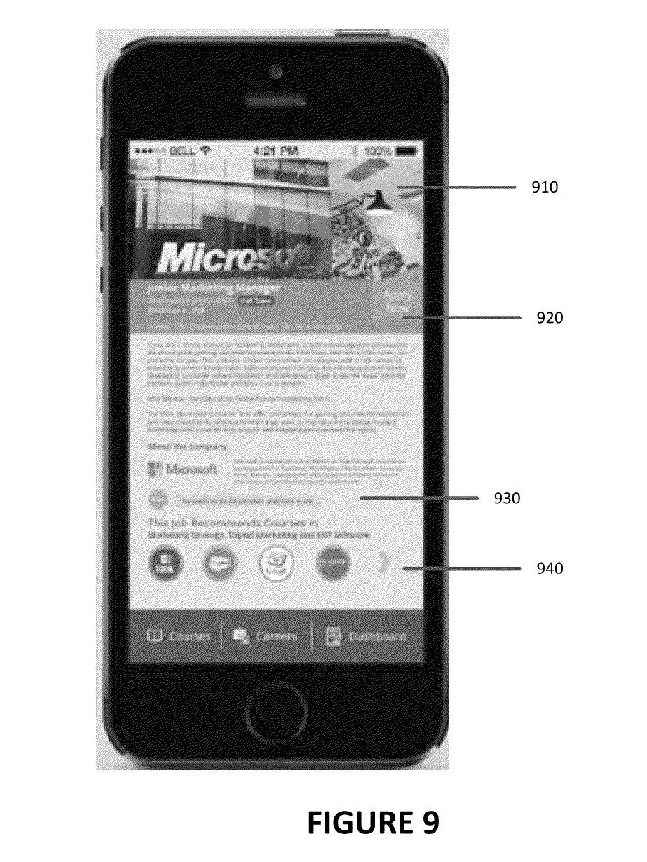

FIG. 9 depicts an embodiment of an interface provided on a computing device for viewing job openings. The interface may allow a user to view a job opening. The job opening may be formatted to a theme specified for a company that has the job opening. Themed company profiles 910 may allow employers to automatically generate visually appealing job posts. For instance, job posts may be themed with company colors and image board the office pictures as a cover for the company profile in the job opening, which may be part of the job opening interface. The interface may include a button 920 that allows the user on the computing device to apply for the job opening. For instance, one click apply makes it easy to apply to jobs, swipe left or right lets you scroll through related jobs that match the user's profile. The interface may further comprise company description, job description, and job requirements 930. In some implementations, the job requirements 930 may comprise one or more skills. The interface may allow the user to apply for a job only if the user qualifies the job by having all the skills in the job requirements 930. The interface may allow the user to only apply to jobs he or she qualifies for, giving equal opportunity to users and quality relevant applicants to employers. The interface may further include a list of recommended courses 940, which may be determined by other jobs in the career path of the job opening, job requirements 930 such as skills that the user may not have, etc. In some implementations, the interface allows the user to scroll through a list of related courses that can either unlock the job opening or help in boosting the user's application on the employer dashboard. For instance, the job opening may have additional optional skills, and if the user acquires those skills via taking courses, the user will match better with the employer of the job opening. In other implementations, an interface displays a plurality of entries or openings. The interface may provide interface elements to filter openings based on job type, date listed, keywords, location, skills, contract type, or any other parameters. As discussed above, in some implementations, only jobs for which the user qualifies for may be shown; in other implementations, jobs for the user does not quite qualify may be shown, along with a list of recommended courses 940 to take or requirements 930 that the user may need to fulfill before applying.

Accordingly, in one aspect, the present disclosure is directed to a method for generating a course selection list. The method includes receiving, by a server from a client computing device, a request identifying an history of a user comprising one or more previously obtained courses and jobs. The method also includes identifying, by an analogous course finder of the server for each of the one or more previously obtained courses, a corresponding one or more predetermined courses in a known course database stored in a storage device of the server. The method further includes identifying, by the analogous course finder from the known course database, skills associated with the one or more predetermined courses, the identified skills added to a profile for the user. The method also includes identifying, by an analogous job finder of the server for each of the one or more previously obtained jobs, a corresponding one or more predetermined jobs in a known jobs database stored in the storage device. The method also includes identifying, by the analogous job finder from the known jobs database, skills associated with the one or more predetermined jobs, the identified skills added to the profile for the user. The method also includes retrieving, by the server, one or more identifications of available jobs from an available jobs database stored in the storage device. The method further includes identifying, by the server, for each of the one or more identifications of available jobs, skills associated with said available job. The method also includes determining, by a skill matcher of the server, a subset of skills common to the profile for the user and each available job. The method also includes identifying, by the skill matcher from the one or more identifications of available jobs, a first available job associated with at least one skill of the subset of skills and associated with a second at least one skill not identified in the profile of the user. The method also includes retrieving, by the server from a storage device, one or more identifications of available courses from an available courses database, each available course associated with one or more skills. The method further includes identifying, by the skill matcher, a first available course associated with the second at least one skill associated with the first available job and not identified in the profile of the user. The method also includes adding, by the skill matcher, the first available course to a list of relevant courses for the user; and transmitting, by the server, the list of relevant courses to the client computing device.

In some implementations, the request further comprises a request to generate the profile for the user. In many implementations, the method includes retrieving, by the server from one or more third party servers, identifications of available jobs; classifying, by an analogous job finder of the server, each retrieved identification of an available job with a predetermined classification, each predetermined classification associated with one or more skills; and storing, by the server, each retrieved identification of an available job and a corresponding predetermined classification to the available jobs database in the storage device. In a further implementation, the method includes identifying, by the server, for each of the one or more identifications of available jobs, the one or more skills associated with the predetermined classification associated with said available job.

In some implementations, the method includes generating, by the server, a list of jobs relevant to the user comprising the first available job; and transmitting, by the server, the list of jobs relevant to the user to the client computing device. In other implementations, the method includes retrieving, by the server from one or more third party servers, identifications of available courses; classifying, by an analogous course finder of the server, each retrieved identification of an available course with a predetermined classification, each predetermined classification associated with one or more skills; and storing, by the server, each retrieved identification of an available course and a corresponding predetermined classification to the available courses database in the storage device.

In some implementations, the method includes identifying, by the server from a career path database stored in the storage device, a first predetermined career path comprising an identification of a target job and an identification of a subjob corresponding to the first available job. The method also includes identifying, by the server, a third at least one skill associated with the target job and not identified in the profile of the user; and identifying, by the skill matcher, a second available course associated with the third at least one skill associated with the target job and not identified in the profile of the user. The method further includes adding, by the skill matcher, the second available course to the list of relevant courses. In a further implementation, the method includes identifying, by the server a second predetermined career path comprising an identification of a second target job and an identification of a subjob corresponding to the first available job. In a still further implementation, the method includes generating, by the server, an ordered list of relevant career paths comprising the first and second predetermined career path, ranked according to a number of available jobs corresponding to subjobs of each career path. In another still further implementation, the method includes generating, by the server, an ordered list of relevant career paths comprising the first and second predetermined career path, ranked according to an expected lifetime income of each career path.

In another aspect, the present disclosure is directed to a server comprising a processor executing an analogous course finder, an analogous job finder, and a skill matcher, and a storage device. The server is configured for receiving, from a client computing device, a request identifying an history of a user comprising one or more previously obtained courses and jobs; retrieving one or more identifications of available jobs from an available jobs database stored in a storage device; identifying, for each of the one or more identifications of available jobs, skills associated with an available job; retrieving, from a storage device, one or more identifications of available courses from an available courses database, each available course associated with one or more skills; and transmitting a list of relevant courses to a client computing device. The analogous course finder is configured for identifying, for each of one or more previously obtained courses, a corresponding one or more predetermined courses in a known course database stored in the storage device of the server; and identifying, from the known course database, skills associated with the one or more predetermined courses, the identified skills added to a profile for the user. The analogous job finder is configured for identifying, for each of one or more previously obtained jobs, a corresponding one or more predetermined jobs in a known jobs database stored in the storage device; and identifying, from the known jobs database, skills associated with the one or more predetermined jobs, the identified skills added to the profile for the user. The skill matcher is configured for determining a subset of skills common to a profile for the user and each available job; identifying from the one or more identifications of available jobs, a first available job associated with at least one skill of the subset of skills and associated with a second at least one skill not identified in the profile of the user; identifying a first available course associated with the second at least one skill associated with the first available job and not identified in the profile of the user; and adding the first available course to the list of relevant courses for the user.

In some implementations, the request further comprises a request to generate the profile for the user. In other implementations, the server is further configured for retrieving, from one or more third party servers, identifications of available jobs, and storing each retrieved identification of an available job and a corresponding predetermined classification to the available jobs database in the storage device. The analogous job finder is further configured for classifying each retrieved identification of an available job with a predetermined classification, each predetermined classification associated with one or more skills. In a still further implementation, the server is further configured for identifying, for each of the one or more identifications of available jobs, the one or more skills associated with the predetermined classification associated with said available job.

In some implementations, the server is further configured for generating a list of jobs relevant to the user comprising the first available job, and transmitting the list of jobs relevant to the user to the client computing device.

In some implementations, the server is further configured for retrieving, from one or more third party servers, identifications of available courses, and store each retrieved identification of an available course and a corresponding predetermined classification to the available courses database in the storage device; and the analogous course finder is further configured for classifying each retrieved identification of an available course with a predetermined classification, each predetermined classification associated with one or more skills. In other implementations, the server is further configured for identifying, from a career path database stored in the storage device, a first predetermined career path comprising an identification of a target job and an identification of a subjob corresponding to the first available job; and identifying a third at least one skill associated with the target job and not identified in the profile of the user. The skill matcher is further configured for identifying a second available course associated with the third at least one skill associated with the target job and not identified in the profile of the user, and adding the second available course to the list of relevant courses. In a further implementation, the server is further configured for identifying a second predetermined career path comprising an identification of a second target job and an identification of a subjob corresponding to the first available job. In a still further implementation, the server is further configured for generating an ordered list of relevant career paths comprising the first and second predetermined career path, ranked according to a number of available jobs corresponding to subjobs of each career path. In another still further implementation, the server is further configured for generating an ordered list of relevant career paths comprising the first and second predetermined career path, ranked according to an expected lifetime income of each career path.

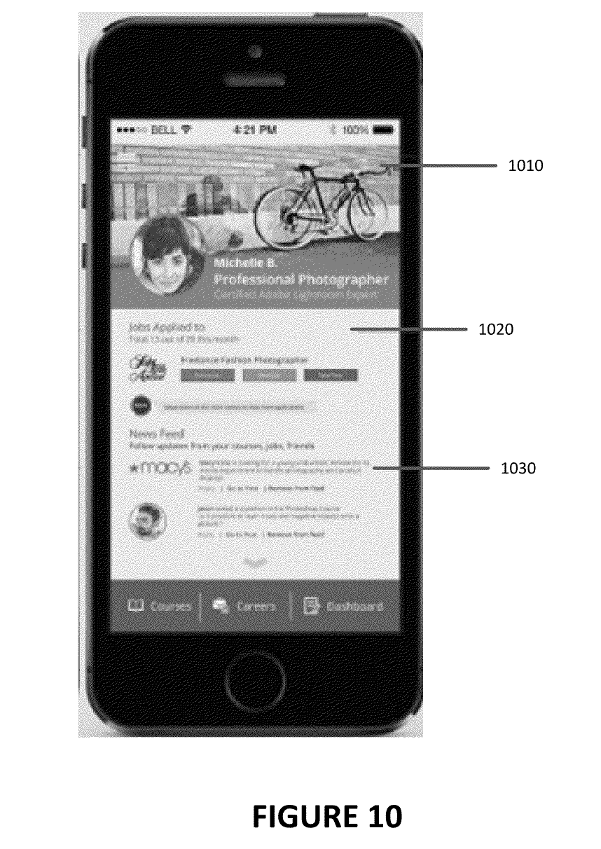

FIG. 10 depicts an embodiment of an interface provided on a computing device for a news feed and job applications. The interface may comprise a customizable profile 1010. In some implementations, the interface may allow the user to completely customize the profile with the ability to change backgrounds (such as images), frame color and titles on display. The interface may comprise an identification of a number of jobs the user has applied to 1020. In some implementations, the interface may display the number of jobs the user has applied to in a predetermined amount of time, for instance in the last month. The user may be limited to a maximum number of job applications per predetermined amount of time. For instance, the user may be limited to twenty job applications per month. In some implementations, user's interaction with the platform may increase the maximum number of job applications per predetermined amount of time. For instance, if the user uses the app every day, the user may be allowed to apply to five additional job applications per month. In another instance, for every course the user completes, the user may be allowed to apply to two additional job applications. The interface may allow the user to manage the job applications and complete assessment test on the go (such as on the mobile phone). The interface may allow the user to navigate between different job applications, via for instance swiping up or down to scroll through the job applications. The interface may further include a news feed 1030. The news feed may push out news from user's courses, friends (on the platform or on one or more social networks connected or linked with the user's account on the platform), and companies that the user follows on the app as well as jobs based on the user's location. The interface may be adjusted by utilizing big data to push the right news at the right time. The news feed may learn over time what matters to a user the most. The news feed may be individualized based on the type of activities on the news feed that the user interacts with. In some implementations, different interfaces may be provided to devices with different screen sizes, e.g. a mobile version may be provided to devices with small screens, such as a smart phone, while another version may be provided to devices with larger screens, such as desktop computers, laptops, tablets.

In another implementation of an interface, the interface may display skills challenges and achievements to encourage users to obtain training or meet goals identified for various positions or jobs. Skills may be displayed in a tree format or similar interface, with prerequisite courses or skills at lower levels of the tree (the “root” or lowest level may be displayed at the top in some implementations, as shown). Nodes of the tree may be selected to identify courses and/or jobs associated with the corresponding skill, allowing a user to quickly identify positions he or she is qualified for, courses he or she should take, etc.

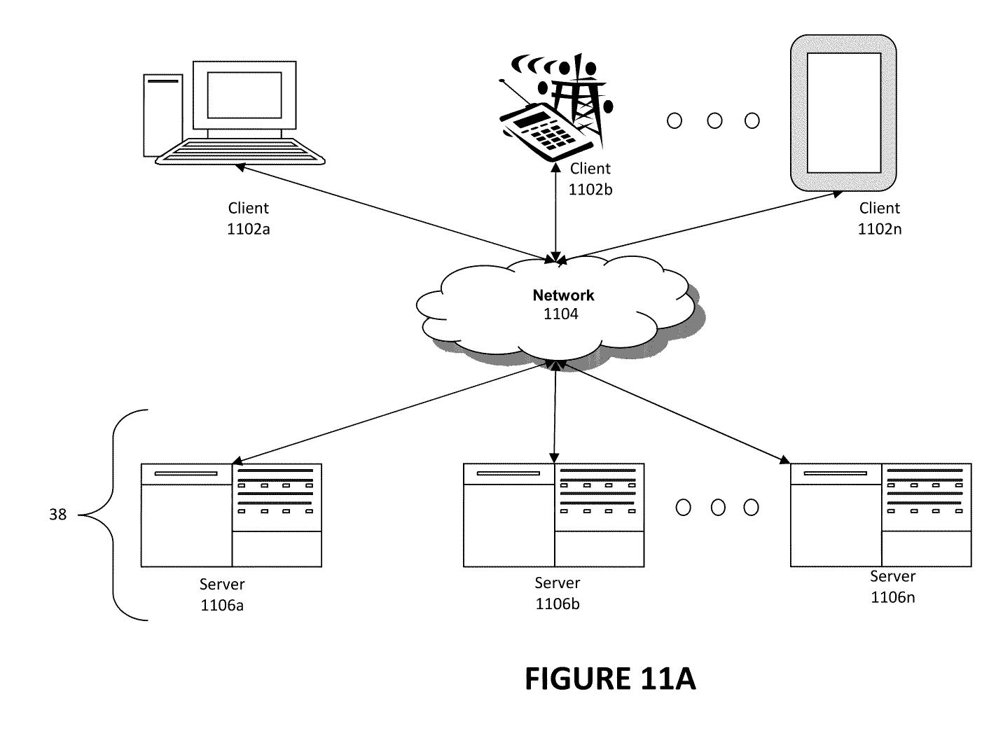

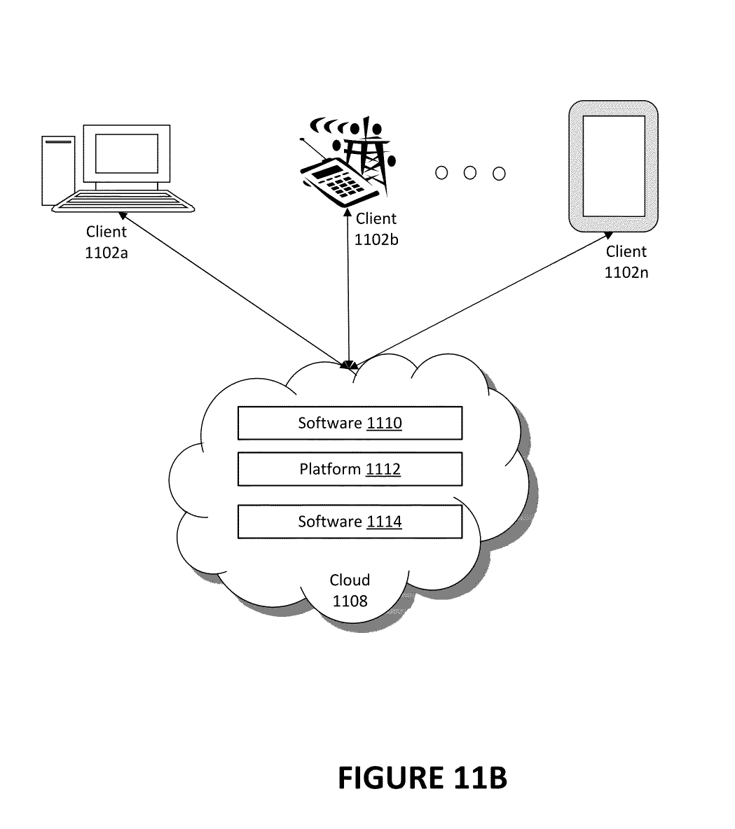

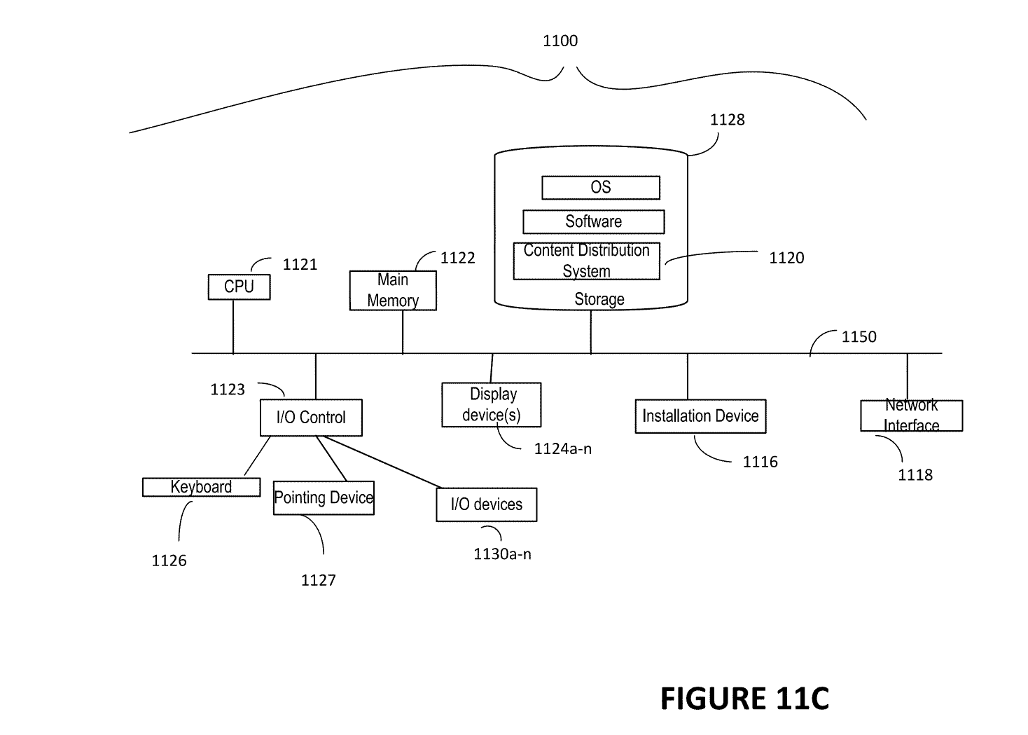

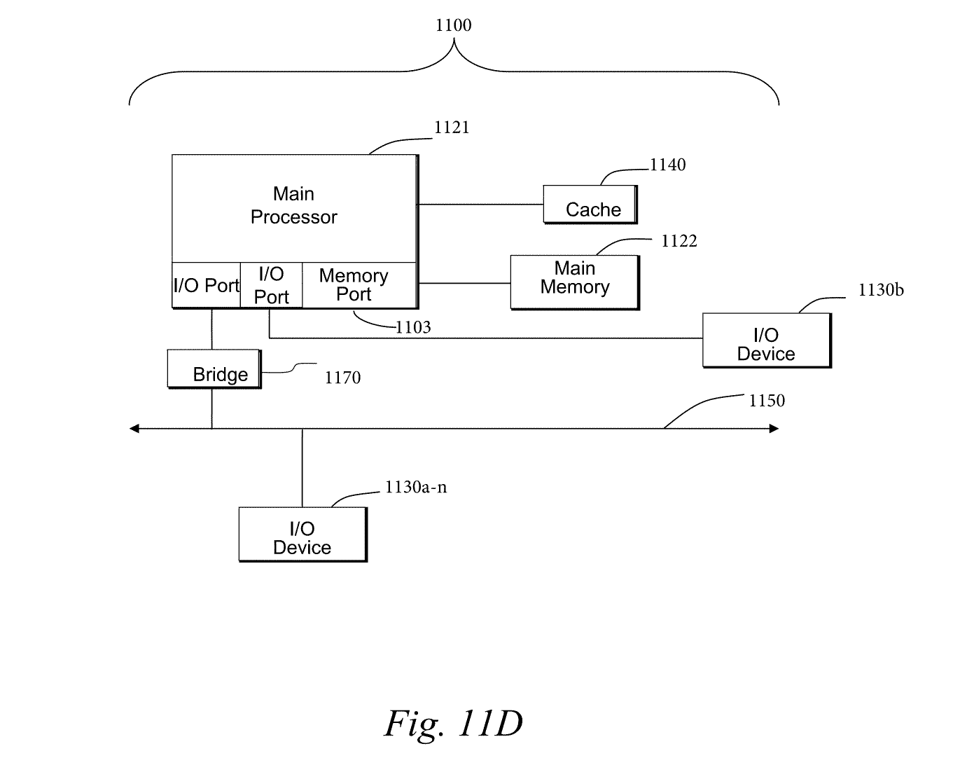

FIG. 11A-D describe aspects of the operating environment as well as associated system components (e.g., hardware elements) in connection with the methods and systems described herein. Referring to FIG. 11A, an embodiment of a network environment is depicted. In brief overview, the network environment includes one or more clients 1102a-1102n (also generally referred to as local machine(s) 1102, client(s) 1102, client node(s) 1102, client machine(s) 1102, client computer(s) 1102, client device(s) 1102, endpoint(s) 1102, or endpoint node(s) 1102) in communication with one or more servers 1106a-1106n (also generally referred to as server(s) 1106, node 1106, or remote machine(s) 1106) via one or more networks 1104. In some embodiments, a client 1102 has the capacity to function as both a client node seeking access to resources provided by a server and as a server providing access to hosted resources for other clients 1102a-1102n.

Although FIG. 11A shows a network 1104 between the clients 1102 and the servers 1106, the clients 1102 and the servers 1106 may be on the same network 1104. In some embodiments, there are multiple networks 1104 between the clients 1102 and the servers 1106. In one of these embodiments, a network 1104′ (not shown) may be a private network and a network 1104 may be a public network. In another of these embodiments, a network 1104 may be a private network and a network 1104′ a public network. In still another of these embodiments, networks 1104 and 1104′ may both be private networks.

The network 1104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 1104 may be any type and/or form of network. The geographical scope of the network 1104 may vary widely and the network 1104 can be a body area network (BAN), a personal area network (PAN), a local-area network (LAN), e.g. Intranet, a metropolitan area network (MAN), a wide area network (WAN), or the Internet. The topology of the network 1104 may be of any form and may include, e.g., any of the following: point-to-point, bus, star, ring, mesh, or tree. The network 1104 may be an overlay network which is virtual and sits on top of one or more layers of other networks 1104′. The network 1104 may be of any such network topology as known to those ordinarily skilled in the art capable of supporting the operations described herein. The network 1104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 1104 may be a type of a broadcast network, a telecommunications network, a data communication network, or a computer network.

In some embodiments, the system may include multiple, logically-grouped servers 1106. In one of these embodiments, the logical group of servers may be referred to as a server farm 38 or a machine farm 38. In another of these embodiments, the servers 1106 may be geographically dispersed. In other embodiments, a machine farm 38 may be administered as a single entity. In still other embodiments, the machine farm 38 includes a plurality of machine farms 38. The servers 1106 within each machine farm 38 can be heterogeneous —one or more of the servers 1106 or machines 1106 can operate according to one type of operating system platform (e.g., WINDOWS NT, manufactured by Microsoft Corp. of Redmond, Wash.), while one or more of the other servers 1106 can operate on according to another type of operating system platform (e.g., Unix, Linux, or Mac OS X).

In one embodiment, servers 1106 in the machine farm 38 may be stored in high-density rack systems, along with associated storage systems, and located in an enterprise data center. In this embodiment, consolidating the servers 1106 in this way may improve system manageability, data security, the physical security of the system, and system performance by locating servers 1106 and high performance storage systems on localized high performance networks. Centralizing the servers 1106 and storage systems and coupling them with advanced system management tools allows more efficient use of server resources.

The servers 1106 of each machine farm 38 do not need to be physically proximate to another server 1106 in the same machine farm 38. Thus, the group of servers 1106 logically grouped as a machine farm 38 may be interconnected using a wide-area network (WAN) connection or a metropolitan-area network (MAN) connection. For example, a machine farm 38 may include servers 1106 physically located in different continents or different regions of a continent, country, state, city, campus, or room. Data transmission speeds between servers 1106 in the machine farm 38 can be increased if the servers 1106 are connected using a local-area network (LAN) connection or some form of direct connection. Additionally, a heterogeneous machine farm 38 may include one or more servers 1106 operating according to a type of operating system, while one or more other servers 1106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 1106 may comprise components, subsystems and modules to support one or more management services for the machine farm 38. In one of these embodiments, one or more servers 1106 provide functionality for management of dynamic data, including techniques for handling failover, data replication, and increasing the robustness of the machine farm 38. Each server 1106 may communicate with a persistent store and, in some embodiments, with a dynamic store.

Server 1106 may be a file server, application server, web server, proxy server, appliance, network appliance, gateway, gateway server, virtualization server, deployment server, SSL VPN server, or firewall. In one embodiment, the server 1106 may be referred to as a remote machine or a node. In another embodiment, a plurality of nodes may be in the path between any two communicating servers.

Referring to FIG. 11B, a cloud computing environment is depicted. A cloud computing environment may provide client 1102 with one or more resources provided by a network environment. The cloud computing environment may include one or more clients 1102a-1102n, in communication with the cloud 1108 over one or more networks 1104. Clients 1102 may include, e.g., thick clients, thin clients, and zero clients. A thick client may provide at least some functionality even when disconnected from the cloud 1108 or servers 1106. A thin client or a zero client may depend on the connection to the cloud 1108 or server 1106 to provide functionality. A zero client may depend on the cloud 1108 or other networks 1104 or servers 1106 to retrieve operating system data for the client device. The cloud 1108 may include back end platforms, e.g., servers 1106, storage, server farms or data centers.

The cloud 1108 may be public, private, or hybrid. Public clouds may include public servers 1106 that are maintained by third parties to the clients 1102 or the owners of the clients. The servers 1106 may be located off-site in remote geographical locations as disclosed above or otherwise. Public clouds may be connected to the servers 1106 over a public network. Private clouds may include private servers 1106 that are physically maintained by clients 1102 or owners of clients. Private clouds may be connected to the servers 1106 over a private network 1104. Hybrid clouds 1108 may include both the private and public networks 1104 and servers 1106.

The cloud 1108 may also include a cloud based delivery, e.g. Software as a Service (SaaS) 1110, Platform as a Service (PaaS) 1112, and Infrastructure as a Service (IaaS) 1114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 1102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 1102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 1102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 1102 may also access SaaS resources through smartphone or tablet applications, including, e.g., Salesforce Sales Cloud, or Google Drive app. Clients 1102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 1102 and server 1106 may be deployed as and/or executed on any type and form of computing device, e.g. a computer, network device or appliance capable of communicating on any type and form of network and performing the operations described herein. FIGS. 11C and 11D depict block diagrams of a computing device 1100 useful for practicing an embodiment of the client 1102 or a server 1106. As shown in FIGS. 11C and 11D, each computing device 1100 includes a central processing unit 1121, and a main memory unit 1122. As shown in FIG. 11C, a computing device 1100 may include a storage device 1128, an installation device 1116, a network interface 1118, an I/O controller 1123, display devices 1124a-1124n, a keyboard 1126 and a pointing device 1127, e.g. a mouse. The storage device 1128 may include, without limitation, an operating system, software, and a software of a content distribution system (CDS) 1120. As shown in FIG. 11D, each computing device 1100 may also include additional optional elements, e.g. a memory port 1103, a bridge 1170, one or more input/output devices 1130a-1130n (generally referred to using reference numeral 1130), and a cache memory 1140 in communication with the central processing unit 1121.

The central processing unit 1121 is any logic circuitry that responds to and processes instructions fetched from the main memory unit 1122. In many embodiments, the central processing unit 1121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 1100 may be based on any of these processors, or any other processor capable of operating as described herein. The central processing unit 1121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 1122 may include one or more memory chips capable of storing data and allowing any storage location to be directly accessed by the microprocessor 1121. Main memory unit 1122 may be volatile and faster than storage 1128 memory. Main memory units 1122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 1122 or the storage 1128 may be non-volatile; e.g., non-volatile read access memory (NVRAIM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 1122 may be based on any of the above described memory chips, or any other available memory chips capable of operating as described herein. In the embodiment shown in FIG. 11C, the processor 1121 communicates with main memory 1122 via a system bus 1150 (described in more detail below). FIG. 11D depicts an embodiment of a computing device 1100 in which the processor communicates directly with main memory 1122 via a memory port 1103. For example, in FIG. 11D the main memory 1122 may be DRDRAM.

FIG. 11D depicts an embodiment in which the main processor 1121 communicates directly with cache memory 1140 via a secondary bus, sometimes referred to as a backside bus. In other embodiments, the main processor 1121 communicates with cache memory 1140 using the system bus 1150. Cache memory 1140 typically has a faster response time than main memory 1122 and is typically provided by SRAM, BSRAM, or EDRAM. In the embodiment shown in FIG. 11D, the processor 1121 communicates with various I/O devices 1130 via a local system bus 1150. Various buses may be used to connect the central processing unit 1121 to any of the I/O devices 1130, including a PCI bus, a PCI-X bus, or a PCI-Express bus, or a NuBus. For embodiments in which the I/O device is a video display 1124, the processor 1121 may use an Advanced Graphics Port (AGP) to communicate with the display 1124 or the I/O controller 1123 for the display 1124. FIG. 11D depicts an embodiment of a computer 1100 in which the main processor 1121 communicates directly with I/O device 1130b or other processors 1121′ via HYPERTRANSPORT, RAPIDIO, or INFINIBAND communications technology. FIG. 11D also depicts an embodiment in which local busses and direct communication are mixed: the processor 1121 communicates with I/O device 1130a using a local interconnect bus while communicating with I/O device 1130b directly.

A wide variety of I/O devices 1130a-1130n may be present in the computing device 1100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 1130a-1130n may include a combination of multiple input or output devices, including, e.g., Microsoft KINECT, Nintendo Wiimote for the WIT, Nintendo WIT U GAMEPAD, or Apple IPHONE. Some devices 1130a-1130n allow gesture recognition inputs through combining some of the inputs and outputs. Some devices 1130a-1130n provides for facial recognition which may be utilized as an input for different purposes including authentication and other commands. Some devices 1130a-1130n provides for voice recognition and inputs, including, e.g., Microsoft KINECT, SIRI for IPHONE by Apple, Google Now or Google Voice Search.

Additional devices 1130a-1130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 1130a-1130n, display devices 1124a-1124n or group of devices may be augment reality devices. The I/O devices may be controlled by an I/O controller 1123 as shown in FIG. 11C. The I/O controller may control one or more I/O devices, such as, e.g., a keyboard 1126 and a pointing device 1127, e.g., a mouse or optical pen. Furthermore, an I/O device may also provide storage and/or an installation medium 1116 for the computing device 1100. In still other embodiments, the computing device 1100 may provide USB connections (not shown) to receive handheld USB storage devices. In further embodiments, an I/O device 1130 may be a bridge between the system bus 1150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 1124a-1124n may be connected to I/O controller 1123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 1124a-1124n may also be a head-mounted display (HMD). In some embodiments, display devices 1124a-1124n or the corresponding I/O controllers 1123 may be controlled through or have hardware support for OPENGL or DIRECTX API or other graphics libraries.

In some embodiments, the computing device 1100 may include or connect to multiple display devices 1124a-1124n, which each may be of the same or different type and/or form. As such, any of the I/O devices 1130a-1130n and/or the I/O controller 1123 may include any type and/or form of suitable hardware, software, or combination of hardware and software to support, enable or provide for the connection and use of multiple display devices 1124a-1124n by the computing device 1100. For example, the computing device 1100 may include any type and/or form of video adapter, video card, driver, and/or library to interface, communicate, connect or otherwise use the display devices 1124a-1124n. In one embodiment, a video adapter may include multiple connectors to interface to multiple display devices 1124a-1124n. In other embodiments, the computing device 1100 may include multiple video adapters, with each video adapter connected to one or more of the display devices 1124a-1124n. In some embodiments, any portion of the operating system of the computing device 1100 may be configured for using multiple displays 1124a-1124n. In other embodiments, one or more of the display devices 1124a-1124n may be provided by one or more other computing devices 1100a or 1100b connected to the computing device 1100, via the network 1104. In some embodiments software may be designed and constructed to use another computer's display device as a second display device 1124a for the computing device 1100. For example, in one embodiment, an Apple iPad may connect to a computing device 1100 and use the display of the device 1100 as an additional display screen that may be used as an extended desktop. One ordinarily skilled in the art will recognize and appreciate the various ways and embodiments that a computing device 1100 may be configured to have multiple display devices 1124a-1124n.

Referring again to FIG. 11C, the computing device 1100 may comprise a storage device 1128 (e.g. one or more hard disk drives or redundant arrays of independent disks) for storing an operating system or other related software, and for storing application software programs such as any program related to the software 1120 for the content distribution system. Examples of storage device 1128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 1128 may be non-volatile, mutable, or read-only. Some storage device 1128 may be internal and connect to the computing device 1100 via a bus 1150. Some storage device 1128 may be external and connect to the computing device 1100 via a I/O device 1130 that provides an external bus. Some storage device 1128 may connect to the computing device 1100 via the network interface 1118 over a network 1104, including, e.g., the Remote Disk for MACBOOK AIR by Apple. Some client devices 1100 may not require a non-volatile storage device 1128 and may be thin clients or zero clients 1102. Some storage device 1128 may also be used as an installation device 1116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 1100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 1102. An application distribution platform may include a repository of applications on a server 1106 or a cloud 1108, which the clients 1102a-1102n may access over a network 1104. An application distribution platform may include application developed and provided by various developers. A user of a client device 1102 may select, purchase and/or download an application via the application distribution platform.

Furthermore, the computing device 1100 may include a network interface 1118 to interface to the network 1104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 1100 communicates with other computing devices 1100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 1118 may comprise a built-in network adapter, network interface card, PCMCIA network card, EXPRESSCARD network card, card bus network adapter, wireless network adapter, USB network adapter, modem or any other device suitable for interfacing the computing device 1100 to any type of network capable of communication and performing the operations described herein.

A computing device 1100 of the sort depicted in FIGS. 11B and 11C may operate under the control of an operating system, which controls scheduling of tasks and access to system resources. The computing device 1100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 1100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 1100 has sufficient processor power and memory capacity to perform the operations described herein. In some embodiments, the computing device 1100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 1100 is a gaming system. For example, the computer system 1100 may comprise a PLAYSTATION 4, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WIT, or a NINTENDO WIT U device manufactured by Nintendo Co., Ltd., of Kyoto, Japan, an XBOX ONE device manufactured by the Microsoft Corporation of Redmond, Wash.

In some embodiments, the computing device 1100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 1100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 1100 is a tablet e.g. the IPAD line of devices by Apple; GALAXY TAB family of devices by Samsung; or KINDLE FIRE, by Amazon.com, Inc. of Seattle, Wash. In other embodiments, the computing device 1100 is a eBook reader, e.g. the KINDLE family of devices by Amazon.com, or NOOK family of devices by Barnes & Noble, Inc. of New York City, N.Y.

In some embodiments, the communications device 1102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 1102 is a laptop or desktop computer equipped with a web browser and a microphone and speaker system, e.g. a telephony headset. In these embodiments, the communications devices 1102 are web-enabled and can receive and initiate phone calls. In some embodiments, a laptop or desktop computer is also equipped with a webcam or other video capture device that enables video chat and video call.

In some embodiments, the status of one or more machines 1102, 1106 in the network 1104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above are apparent in the context of the systems and methods disclosed herein.

What is claimed is:

1. A method for generating a course selection list, the method comprising:
receiving, by a server from a client computing device, a request identifying an history of a user comprising one or more previously obtained courses and jobs;
identifying, by an analogous course finder of the server for each of the one or more previously obtained courses, a corresponding one or more predetermined courses in a known course database stored in a storage device of the server;
identifying, by the analogous course finder from the known course database, skills associated with the one or more predetermined courses, the identified skills added to a profile for the user;
identifying, by an analogous job finder of the server for each of the one or more previously obtained jobs, a corresponding one or more predetermined jobs in a known jobs database stored in the storage device;
identifying, by the analogous job finder from the known jobs database, skills associated with the one or more predetermined jobs, the identified skills added to the profile for the user;
retrieving, by the server, one or more identifications of available jobs from an available jobs database stored in the storage device;
identifying, by the server, for each of the one or more identifications of available jobs, skills associated with said available job;
determining, by a skill matcher of the server, a subset of skills common to the profile for the user and each available job;
identifying, by the skill matcher from the one or more identifications of available jobs, a first available job associated with at least one skill of the subset of skills and associated with a second at least one skill not identified in the profile of the user;
retrieving, by the server from a storage device, one or more identifications of available courses from an available courses database, each available course associated with one or more skills;
identifying, by the skill matcher, a first available course associated with the second at least one skill associated with the first available job and not identified in the profile of the user;
adding, by the skill matcher, the first available course to a list of relevant courses for the user; and
transmitting, by the server, the list of relevant courses to the client computing device.

2. The method of claim 1, wherein the request further comprises a request to generate the profile for the user.

3. The method of claim 1, further comprising:
retrieving, by the server from one or more third party servers, identifications of available jobs;
classifying, by an analogous job finder of the server, each retrieved identification of an available job with a predetermined classification, each predetermined classification associated with one or more skills; and
storing, by the server, each retrieved identification of an available job and a corresponding predetermined classification to the available jobs database in the storage device.

4. The method of claim 3, wherein identifying skills associated with an available job further comprises:
identifying, by the server, for each of the one or more identifications of available jobs, the one or more skills associated with the predetermined classification associated with said available job.

5. The method of claim 1, further comprising:
generating, by the server, a list of jobs relevant to the user comprising the first available job; and
transmitting, by the server, the list of jobs relevant to the user to the client computing device.

6. The method of claim 1, further comprising:
retrieving, by the server from one or more third party servers, identifications of available courses;
classifying, by an analogous course finder of the server, each retrieved identification of an available course with a predetermined classification, each predetermined classification associated with one or more skills; and
storing, by the server, each retrieved identification of an available course and a corresponding predetermined classification to the available courses database in the storage device.

7. The method of claim 1, further comprising:
identifying, by the server from a career path database stored in the storage device, a first predetermined career path comprising an identification of a target job and an identification of a subjob corresponding to the first available job;
identifying, by the server, a third at least one skill associated with the target job and not identified in the profile of the user;
identifying, by the skill matcher, a second available course associated with the third at least one skill associated with the target job and not identified in the profile of the user; and
adding, by the skill matcher, the second available course to the list of relevant courses.

8. The method of claim 7, further comprising:
identifying, by the server a second predetermined career path comprising an identification of a second target job and an identification of a subjob corresponding to the first available job.

9. The method of claim 8, further comprising generating, by the server, an ordered list of relevant career paths comprising the first and second predetermined career path, ranked according to a number of available jobs corresponding to subjobs of each career path.

10. The method of claim 8, further comprising generating, by the server, an ordered list of relevant career paths comprising the first and second predetermined career path, ranked according to an expected lifetime income of each career path.

11. A system, comprising:
a server comprising a processor executing an analogous course finder, an analogous job finder, and a skill matcher, and a storage device;
wherein the server is configured for:
receiving, from a client computing device, a request identifying an history of a user comprising one or more previously obtained courses and jobs,
retrieving one or more identifications of available jobs from an available jobs database stored in a storage device,
identifying, for each of the one or more identifications of available jobs, skills associated with an available job,
retrieving, from a storage device, one or more identifications of available courses from an available courses database, each available course associated with one or more skills, and
transmitting a list of relevant courses to a client computing device;
wherein the analogous course finder is configured for:
identifying, for each of one or more previously obtained courses, a corresponding one or more predetermined courses in a known course database stored in the storage device of the server, and
identifying, from the known course database, skills associated with the one or more predetermined courses, the identified skills added to a profile for the user;
wherein the analogous job finder is configured for:
identifying, for each of one or more previously obtained jobs, a corresponding one or more predetermined jobs in a known jobs database stored in the storage device, and
identifying, from the known jobs database, skills associated with the one or more predetermined jobs, the identified skills added to the profile for the user; and
wherein the skill matcher is configured for:
determining a subset of skills common to a profile for the user and each available job,
identifying from the one or more identifications of available jobs, a first available job associated with at least one skill of the subset of skills and associated with a second at least one skill not identified in the profile of the user,
identifying a first available course associated with the second at least one skill associated with the first available job and not identified in the profile of the user, and
adding the first available course to the list of relevant courses for the user.

12. The system of claim 11, wherein the request further comprises a request to generate the profile for the user.

13. The system of claim 11, wherein:
the server is further configured for retrieving, from one or more third party servers, identifications of available jobs, and
storing each retrieved identification of an available job and a corresponding predetermined classification to the available jobs database in the storage device; and
wherein the analogous job finder is further configured for classifying each retrieved identification of an available job with a predetermined classification, each predetermined classification associated with one or more skills.

14. The system of claim 13, wherein the server is further configured for identifying, for each of the one or more identifications of available jobs, the one or more skills associated with the predetermined classification associated with said available job.

15. The system of claim 11, wherein the server is further configured for generating a list of jobs relevant to the user comprising the first available job, and transmitting the list of jobs relevant to the user to the client computing device.

16. The system of claim 11, wherein:
the server is further configured for retrieving, from one or more third party servers, identifications of available courses, and store each retrieved identification of an available course and a corresponding predetermined classification to the available courses database in the storage device; and
wherein the analogous course finder is further configured for classifying each retrieved identification of an available course with a predetermined classification, each predetermined classification associated with one or more skills.

17. The system of claim 11, wherein:
the server is further configured for:
identifying, from a career path database stored in the storage device, a first predetermined career path comprising an identification of a target job and an identification of a subjob corresponding to the first available job, and
identifying a third at least one skill associated with the target job and not identified in the profile of the user; and
wherein the skill matcher is further configured for
identifying a second available course associated with the third at least one skill associated with the target job and not identified in the profile of the user, and
adding the second available course to the list of relevant courses.

18. The system of claim 17, wherein the server is further configured for identifying a second predetermined career path comprising an identification of a second target job and an identification of a subjob corresponding to the first available job.

19. The system of claim 18, wherein the server is further configured for generating an ordered list of relevant career paths comprising the first and second predetermined career path, ranked according to a number of available jobs corresponding to subjobs of each career path.

20. The system of claim 18, wherein the server is further configured for generating an ordered list of relevant career paths comprising the first and second predetermined career path, ranked according to an expected lifetime income of each career path.
